(19) United States
(12) Patent Application Publication
(10) Pub. No.: US 2004/0111344 A1
(43) Pub. Date: Jun. 10, 2004

(54) Financial data reporting system

(76) Inventors: David S. Fetter, Superior, CO (US); Robert J. O'Byrne, Highlands Ranch, CO (US); K. Wade Turner, Westminster, CO (US)

Correspondence Address: HEIMBECHER & ASSOCIATES, LLC., 200 UNION BLVD, SUITE 316, LAKEWOOD, CO, 80228-1831, US

(21) Appl. No.: 10/465,360

(22) Filed: Jun. 18, 2003

Related U.S. Application Data
(60) Provisional application No. 60/389,805, filed on Jun. 18, 2002.

(51) Int. Cl. G06F 17/60

(52) U.S. Cl. 705/35

(57) ABSTRACT

A method and system for processing financial transaction data and generating reports. The present embodiment may create a variety of reports from data provided by a plurality of data sources. The present invention may create customized reports in customized formats to satisfy a client's unique reporting needs. Further, minimum programming effort and customization time is required due to the modularity of the method and system.

### CROSS REFERENCE TO RELATED APPLICATIONS

This application claims priority to U.S. Provisional Application Serial No. 60/389,805, filed Jun. 18, 2002 and entitled “Financial Data Reporting System,” naming David S. Fetter, Robert J. O'Byrne and K. Wade Turner as inventors, which is incorporated herein by reference in its entirety.

### APPENDICES

Appendices A, B, C, and D attached hereto are hereby incorporated by reference as though fully set forth in the specification. Appendix A (8 pages) provides a sample base data table (in this case, T_BILLING) for use by a net commissions module. Appendix B (1 page) provides a sample T_COMM_DETAIL summary data table, and Appendix C (1 page) provides a sample T_COMM_NETPAYABLE summary data table, both of which are generated from the sample base table of Appendix A. Definitions for the various values comprising each data entry may be seen in Appendix D (3 pages).

### BACKGROUND OF THE INVENTION

a. Field of the Invention

The invention relates generally to data processing, and more specifically to methods and systems for processing and manipulating financial data to generate financial reports.

b. Background Art

Ever since the first stocks were traded on Wall Street in the 1700s, securities brokering has become ever more complicated. The rise of the New York Stock Exchange in 1817 began the formalization of purchases and sales, setting down rules of business. Similarly, the first brokerage firms probably created internal trading rules governing the conduct and activities of all affiliated dealers.

As technology has changed the shape of the world, so too has it impacted financial markets. Orders may be placed and executed faster, securities may be easily tracked, and the range of security reporting options has grown. With the unprecedented flexibility brought about by the advent of computers in securities trading, a similar leap in the complexity of tracking broker activities, commissions, and compliance reporting has taken place. Today, a bewildering array of data is available from dealers, clearing firms, compliance organizations, and so on. Further, this data may come in any number of forms and formats. Simply processing the data to create intelligible, meaningful results for a financial client is a challenge. This is true whether a client wishes to see a report detailing the commissions for its brokers during a certain time period, a compliance report highlighting dealer activities that may raise flags with the National Association of Securities Dealers (NASD), a profit and loss report showing the client's income, and so on.

Further complicating the gathering, manipulation, and reporting of financial data for clients is the fact that each client typically has special needs. Some clients may want to see reports showing enhanced compliance reports for specific brokers who have previously violated trading rules, while requiring simplified compliance reports for “clean” brokers. Other clients may track activity in certain equities more closely than in others, desiring a minute-by-minute position breakdown for each move made into or out of the equity. Yet other clients may want to review their profits on a daily, weekly, or even hourly basis rather than once a month.

Because so many clients have unique cases, prepackaged software solutions rarely meet a client's every need. Instead, many clients must spend months or years and vast sums of money customizing prepackaged software. Oftentimes, such software is limited in the amount and types of data it may receive and manipulate, possibly forcing a client to either create custom data import programs or do without a valuable report. For many brokers, clearing firms, and other financial entities, these are unacceptable options.

One example of a prepackaged software application widely used by financial institutions is a platform that accepts a limited set of data from a handful of clearing firms, clients, brokerages, and so on (collectively, “data sources”). Although many data sources generate and transmit large amounts of data to a client, this widely-used platform ignores a substantial portion of the available information. Instead, the platform accepts only the data that the software package is hard-coded to manipulate. Accordingly, a client using this platform is inherently limited in the nature of and types of reports that may be generated by the incomplete data accepted by that platform's front end.

Further, it is extremely difficult to generate custom reports or databases with this widely-used platform. In order to accept nonstandard data, the platform's input routines must be nearly completely rewritten. Further, large portions of the platform must then be changed in order to accommodate, store, and manipulate new data. This is a lengthy process that may take months or even years to complete. By the time such data is available for a customer's use, it may be obsolete or replaced by a new data format, thus starting the entire cycle again.

The widely-used platform discussed in the last few paragraphs is but one of several prepackaged software suites available to financial entities, such as brokerages, independent dealers, clearing firms, and so forth. All such software packages, however, suffer from the problems described above. Limited customization, minimal input data sets, and fixed report generation all combine to stifle a client's ability to review and report data in the manner it desires. Accordingly, there is a need in the art for an improved financial data reporting system.

### SUMMARY OF THE INVENTION

Generally, the invention comprises a method and system for processing financial transaction data and generating reports therefrom. The present embodiment may, for example, create a variety of commission reports useful in reporting, tracking, and analyzing commission data from data transmitted from multiple data sources. Data sources include clearing firms, brokerages, regulatory bodies, manually inputted user data, and so forth.

Clients, such as brokerage firms, dealers, individual traders, and others desiring financial reports, often have unique reporting requirements. As used in this specification, “client” refers to any entity desiring financial reporting capabilities in accordance with the present invention for itself or its downstream clients or users. Depending on the nature of the use, a “client” may be an individual dealer, a brokerage, a clearing firm, and so forth.

Some clients may offer discounted trades to investors on certain days, while other clients may charge a lower commission on purchases of securities originating in-house, such as some mutual funds. These types of special deals make general financial reporting unique to each client. Further, many clients prefer their reports to conform to specific layouts. Thus, most clients require some form of unique reporting capabilities. The present invention may generate any type of report in any format desired, while simultaneously taking into account any unique client needs. Further, minimum programming effort and customization time is required due to the modularity of the invention.

First, all data transmitted from any data source (“raw data”) is stored in one or more raw data tables. The present embodiment does not cull a portion of the data from data transmissions, but instead stores every item provided by a data source. Since all raw data is accepted, all data is available for processing and analysis by the embodiment. Accordingly, custom report generation is simplified because the entire system need not be changed to accept or evaluate ordinarily amended or custom data that may be required for a customized report. If additional data sources are needed, they may take the form of manually maintained tables or automated custom data sources. Either way, these additional data sources may include information provided by a client or a user of the present embodiment. The present embodiment is flexible enough to accept almost any form of customized data source.

The raw data is typically extracted from files provided by a data source and stored as entries in one or more raw data tables. The raw data tables used by the present invention typically are SQL database tables, although other database formats may be used.

In one embodiment, the system extracts the raw data from the raw data tables, manipulates the raw data, and stores the manipulated data in at least one base data table. In an alternate embodiment, the system determines what subset of entries in the raw data tables contains data relevant to the generation of a custom report for a client. Once that relevant data set is determined, the alternate embodiment extracts that data from the raw-data tables and uses it to create one or more base data tables. Again, the base data tables are typically SQL database tables, but may be in other formats.

Additionally, one or more manual inputs may be stored as an entry in a manually maintained table. Data entries from one or more manually maintained tables may also be manipulated and stored as one or more entries in one or more base data tables.

The present invention may combine or otherwise manipulate data from multiple data sources into a single entry in a base data table. For example, a client may place a transaction through a clearing firm. The client may log one side of the transaction (namely, the act of placing the transaction with the firm), while the clearing firm records the rest of the transaction (i.e., the actual purchase or sale on an open market of a security). If both the client and the clearing firm act as data sources, the present invention may compare data entries in raw data tables and determine that the two entries corresponding to the client's and clearing firm's raw data represent different or possibly overlapping portions of the same transaction. In such case, the embodiment may combine the raw data entries into a single base data table entry for the transaction.

Supplemental data tables may also be created by manipulating data entries in either the raw data tables, base data tables, or both. Supplemental data tables generally contain data entries that do not conform to the data layouts of a base data table.

Once custom reports and customized data sources have been identified for each client's unique case, custom programming to manipulate the data sources and generate a custom report may be required. Typically, this custom programming takes place in the net commission, profit/loss, FLI reports, and/or portfolio reporting data processing modules. Generally speaking, such customized programming may take any shape or form necessary to manipulate a custom data source and generate a custom report. In the present embodiment, the vast majority of customization takes place in these modules. Other portions of the present embodiment are generally static, forming the base system to which customized programming may be quickly added.

The custom programming processes data entries in the base data tables (and supplemental data tables, if any) to create one or more summary data tables. A summary data table contains data entries in a substantially final format, ready to be used in one or more reports. Reports may be generated from one or more summary data tables by the present invention for a client's perusal.

### BRIEF DESCRIPTION OF THE DRAWINGS

FIG. 1 is a flowchart displaying a method for interviewing a client according to one aspect of the present invention to determine a set of unique reporting cases.

FIG. 2 displays a system-level overview of the operation of an embodiment of the present invention.

FIG. 3 displays a system diagram of one embodiment of the present invention.

FIG. 4 displays a system diagram of a second embodiment of the present invention.

FIG. 5 displays a system diagram of a third embodiment of the present invention.

FIG. 6 displays a system diagram of a fourth embodiment of the present invention.

FIG. 7 displays a system diagram of a fifth embodiment of the present invention.

FIG. 8 displays an overview of the net commissions module in accordance with an embodiment of the present invention.

FIG. 9 displays an import scheme for accepting raw data from a first data source and converting the data to raw data table entries.

FIG. 10 displays an import scheme for accepting raw data from a second data source and converting the data to raw data table entries.

FIG. 11 displays an import scheme for accepting raw data from a third data source and converting the data to raw data table entries.

FIG. 12 displays an import scheme for accepting raw data from a fourth data source and converting the data to raw data table entries.

FIG. 13 displays an import scheme for accepting raw data from a fifth data source and converting the data to raw data table entries.

FIG. 14 displays an import scheme for accepting raw data from a sixth data source and converting the data to raw data table entries.

FIG. 15 is a flow diagram displaying a method for converting raw data table and manually maintained table entries into summary data tables.

FIG. 16 is a flow diagram detailing the data extraction process of FIG. 15.

FIG. 17 is a flow diagram detailing the summary data table generation process of FIG. 15.

FIGS. 18A-18E display pseudocode for sample special processing in accordance with an embodiment of the present invention.

FIGS. 19A-G display pseudocode for sample special processing in accordance with an embodiment of the present invention.

### DETAILED DESCRIPTION OF THE INVENTION

General Operation of the Invention

Generally, the invention comprises a method and system for processing financial transaction data and generating or extracting one or more reports. In the present embodiment, these reports comprise a variety of commission reports useful in reporting, tracking, and analyzing commission data. The invention can accept a variety of data from multiple data sources such as clearing firms, clients, compliance and oversight organizations, the user, and so forth. The system may accept any form of alphanumerical or symbolic data.

Generally, data transmitted from any data source is accepted in its entirety and stored in a database table. Since all raw data is accepted, all data is available for processing and analysis by the embodiment. Accordingly, the generation of custom reports is simplified because the entire system need not be changed to accept or evaluate typically unused raw data required for a customized report.

As previously mentioned, the present invention may accept data from a variety of sources, including a clearing firm, client or other end user of the embodiment. Such data may either be inputted manually in the form of a manually maintained table (discussed in more detail below), or inputted automatically into the system as a routinely accepted data source. In the latter case, automatic input may occur at regular intervals, such as every day or hour. Alternately, one or more manually maintained tables may be updated as necessary.

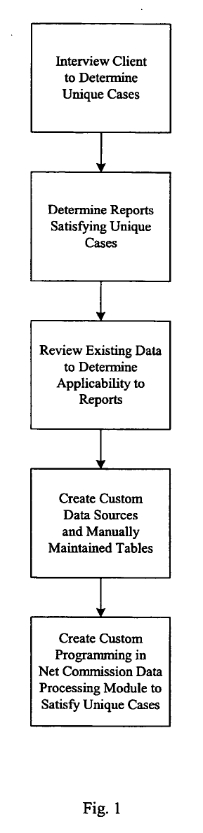

In order to define the type of customized reports desired, the extent and nature of customized programming necessary to create the report, and the types of nonstandard data sources used to generate the report, a client or other end user must be carefully interviewed to determine the client's needs and wants. Typically, each client will require certain specialized reports, which are referred to hereinafter as “unique cases.” FIG. 1 displays an exemplary method 100 for implementing and satisfying unique cases within the context of the present embodiment. First, the client is interviewed in operation 110 to determine what, if any, unique cases exist in his or her business. For example, some clients may waive broker fees for all transactions placed on Tuesday afternoons, while others may charge non-standard commissions on all mutual fund trades. After each client's unique cases are determined, standardized reports may be reviewed to determine whether any such reports satisfy these unique cases. Typically, this is not the case.

When no existing reports satisfy a client's unique cases, new, customized reports must be generated in operation 120. Of course, the format of such reports is also entirely customizable, thus permitting the client great flexibility in report generation and formatting. Once a customized report and report format are found that satisfy a client's unique case, existing data sources may be analyzed in operation 140 to see if the custom report may be generated solely from the existing data sources.

If additional data sources are needed, they may take the form of manually maintained tables or custom automated data inputs. Either the manually maintained table or automated data inputs may include information provided by the client or a third party. The present embodiment is flexible enough to accept almost any form of customized data input from any data source.

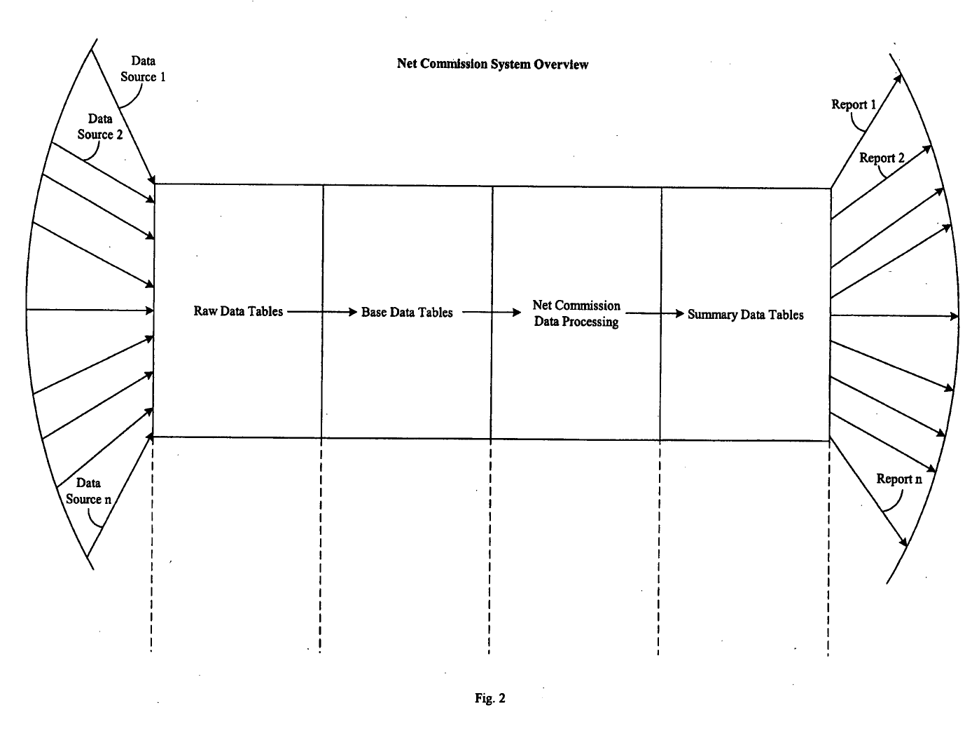

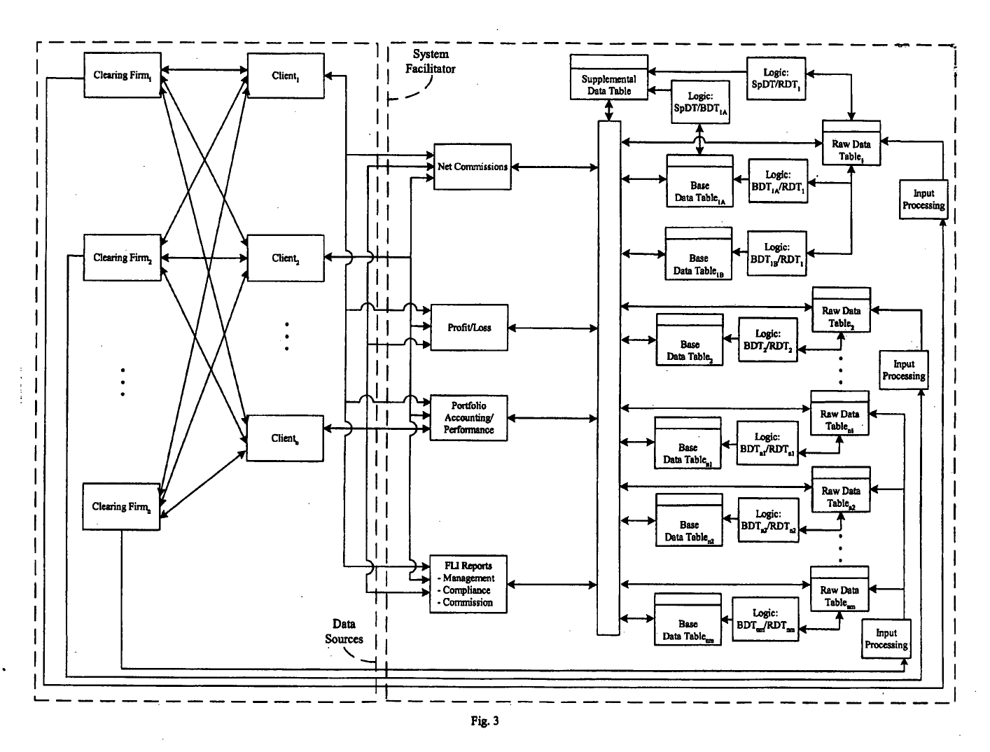

Finally, once custom reports and customized data inputs have been identified for each client's unique case, custom programming to manipulate the available data and generate a custom report may be required. Typically, this custom programming takes place in the net commission or other data processing module and is generated in operation 150. Generally speaking, such customized programming may take any form necessary to manipulate standard and custom data and generate a custom report. It should be noted that the processing modules contain the vast majority of custom code, with other elements of the present embodiment being essentially fixed. The particulars of converting raw data into desired reports is described more fully with respect to FIGS. 2 through 19G, below.

Overview of an Embodiment

FIG. 2 shows a block diagram of the general operation of an embodiment 200 of the present invention. Data is accepted from multiple data sources 210a, 210b, . . . 210n, and converted into raw data tables 220. As previously mentioned, any and all data provided from a data source 210a may be stored in one or more raw data tables 220. Generally speaking, no data is culled, thrown away, or otherwise ignored. Instead, all data is stored in at least one raw data table. Further, data provided by data sources 210a, 210b, . . . 210n may be reformatted prior to being entered into a raw data table 220.

For example, a data source 210 may routinely provide a twelve-digit number, where the final three digits are to the right of a decimal point and zeros are added to the left until twelve digits are present. That is, the number 7112.50 would be represented as “000007112500” using this scheme. Since the data format is constant in this example, the present embodiment may routinely reformat the above number as “7112.50” prior to entering it into a raw data table 220. Alternately, this reformatting may take place during the creation of base data table 230 entries, as described below.

Although not all data stored in the raw data tables 220 is relevant to the reports generated by the present embodiment 200, the present embodiment nonetheless converts all entries in the raw data tables 220 into base data tables 230. Data is extracted from the raw data tables 220 and placed in one or more base data tables 230. Further, some formatting of the raw data contained in the raw data tables may take place when the data is transferred to a base data table. In transferring data from the raw data tables 220 to one or more base data tables 230, data entries may also be combined into a single base data table entry or grouped with entries from other raw data tables. In this manner, if additional custom reports are required by a client at a later date and such custom reports require previously unnecessary data, the reports may be quickly and easily generated from the complete data set already present in the raw data tables 220.

Next, the data stored in the base data tables 230 is processed to form inputs for one or more summary data tables 240. This operation, carried out by the “Net Commission Data Processing” module 250 of FIG. 2, is the procedure by which data is manipulated into a final format prior to report generation. Generally, the present embodiment 200 determines which entries in one or more base data tables 230 are required to create one or more reports 260a, 260b, . . . 260n satisfying a client's unique cases. The data necessary for each report is then extracted from a base data table 230 and placed in a dedicated summary data table 240. This operation 250, then, represents culling presently unnecessary data from the base data tables 230 and creating a database having only information necessary to report 260 generation. It should be noted, however, that such “unnecessary” data is still kept in the raw 220 and base 230 data tables. In this manner, if additional custom reports 260a, 260b, . . . 260n are required by a client at a later date and such custom reports require previously unnecessary data, the reports may be quickly and easily generated from the complete data sets still stored by the embodiment 200. In an alternate embodiment, this “culling” operation may take place when transferring data from one or more raw data tables 220 to one or more base data tables 230.

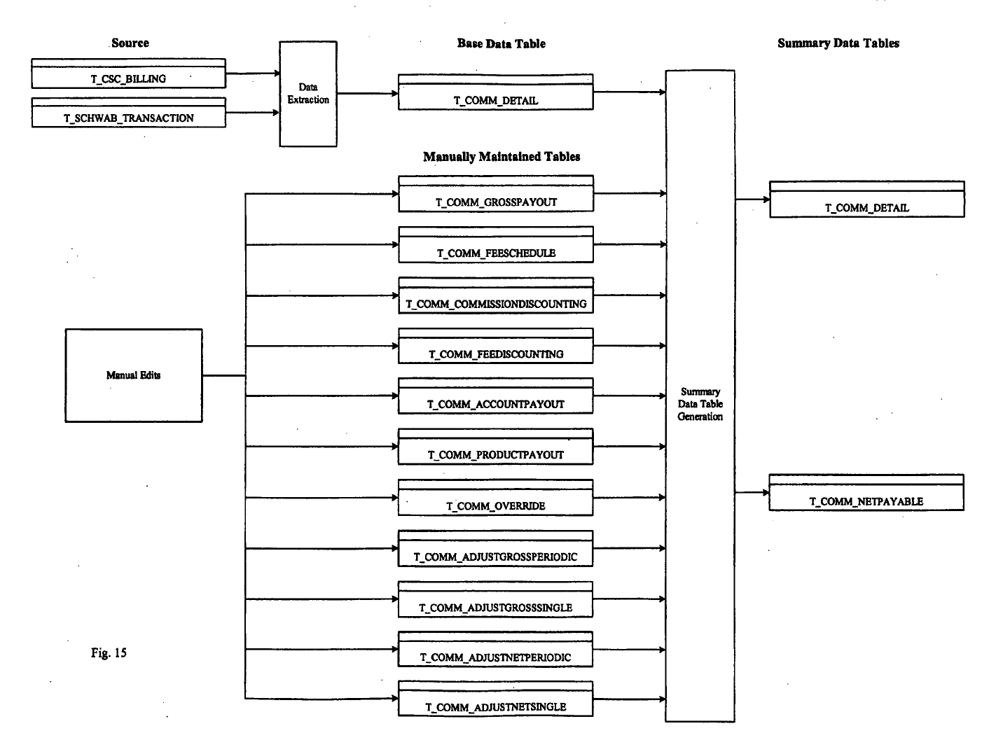

Because each client has its own set of unique cases, this operation may vary on a case-by-case basis. General examples of the net commission data processing module 250 operation are given with reference to FIGS. 15-17, below. Further, alternative types of financial processing may be substituted for the net commission processing module 250 without changing the general operation of the embodiment 200. Such alternative processes (including profit/loss calculations, portfolio accounting/performance calculations, and management, compliance and commission reporting) are explained below.

Once the data in the base data tables 230 has been processed as necessary for each client's unique cases, the data is stored in one or more summary data tables 240. Reports 260a, 260b, . . . 260n are then generated from the summary data tables.

Reports 260a, 260b, . . . 260n may come in many different formats. For example, reports may be formatted as a hypertext markup language (HTML) document, a word processing document, a simple text document, an electronic mail document, and so forth. Further, reports 260a, 260b, . . . 260n may be sent directly to a printer and printed in hard copy, or kept electronically.

It should be noted that, due to the modularity of the present embodiment, any of the data processing or data gathering operations mentioned above may be performed at a number of locations. For example, data may be transmitted from one or more data sources 210a, 210b, . . . 210n across a network, such as the Internet, an intranet, a local area network (LAN), a wide area network (WAN), a wireless network, and so forth to a remote location, such as a server. The server or other computer may accept the data and store it in one or more raw data tables 220. If necessary, the raw data tables 220 may be transmitted to yet another location where relevant data is extracted from the raw data tables and formatted for entry into base data tables 230. These base data tables 230 may then be transmitted to a third location for further processing in order to create summary data tables 240, and reports 260a, 260b, . . . 260n may be generated at a fifth location. Finally, the reports generated from summary data tables may be transmitted via a network to a client. In this case, the reports 260a, 260b, . . . 260n may not only take a number of formats, such as those listed above, but also may be transmitted in a variety of ways.

Alternately, any or all of the processing modules may operate at a single location. For example, one location could accept data from multiple data sources 210a, 210b, . . . 210n, store the data in raw data tables 220, convert the data to one or more base data tables 230, and so forth, up to and including the generation of one or more reports 260a, 260b, . . . 260n. Continuing the example, this may occur when a client wishes to operate the present invention in-house. It should be understood that both the distributed and unified models are embraced by the spirit and scope of the present invention.

Operation of One Embodiment

FIG. 3 displays a system diagram showing one embodiment 300 of the present invention. One or more data sources 210, such as clearing firms 310a, 310b, . . . 310n and clients 320a, 320b, . . . 320n, transmit data to a system facilitator 330. Typically, this data is transmitted as one or more files. Data is removed from these files and stored as one or more entries in one or more raw data tables 220a, 220b, . . . 220na, 220nb, . . . 220nm, as represented by the “Input Processing” logical blocks 340a, 340b. The input processing may also entail formatting one or more data entries, as necessary. Typically, the raw data tables 220 (and all other tables in the present embodiment) are SQL database tables. SQL databases provide simplified data manipulation, storage, and processing and are well-known in the art.

Depending on the nature of the data contained in the files received from the data sources 210, the data may be entered into one or more raw data tables 220. Each data source 210 may have one or more raw data tables 220a, 220b, . . . 220na, 220nb, . . . 220nm associated with it. For example, as seen in FIG. 3, Clearing Firm₁ 310a may transmit data that is entered into Raw Data Table₁ 220a, while Clearing Firmₙ 310n may transmit data that is entered into Raw Data Tableₙ₁ 220na through Raw Data Tableₙₘ 220nm. Further, one datum transmitted by Clearing Firmₙ 310n may be entered simultaneously into Raw Data Tableₙ₁ 220na, Raw Data Tableₙ₂ 220nb, and so forth. The number of raw data tables 220 associated with either a given datum or a given data source 220 varies depending on both the data source and the client's unique cases.

Next, the raw data is taken from a raw data table 220, manipulated, and placed into one or more base data tables 230a, 230b, 230c, . . . 230na, 230nb, . . . 230nm. This is represented by the blocks 350a, 350b, 350c, 350d, 350c, 350e, 350f entitled “Logic: BDT/RDT.” As with the raw data tables 220a, 220b, . . . 220na, 220nb, . . . 220nm, the base data tables are typically SQL database tables. Additionally, one or more manually maintained tables (not shown in FIG. 3) may also contain data that is extracted and possibly manipulated to form a portion of the base data tables 230a, 230b, 230c, . . . 230na, 230nb, . . . 230nm. Manually maintained tables generally have one or more manually inputted entries, which may represent such items as one time client events, irregular transactions, special discounts, and so forth. Entries from the manually maintained tables are retrieved and converted into base data table 230 entries in much the same manner as described above with respect to raw data table conversion. Data pulled from either a raw data table 220 or a manually maintained table and inserted into a base data table 230 may be further formatted, as necessary. It should be noted that an entry in a raw data table 220 may be used in generating more than one base data table 230 entry. For example, one or more entries from Raw Data Table₁ 220a of FIG. 3 may be used in both Base Data Table_{1A} 230b and Base Data Table_{1B} 230b.

In addition to the base data tables 230a, 230b, 230c . . . 230na, 230nb, . . . 230nm, one or more supplemental data tables 365 may be created from other data table entries. Entries from the raw data table 220 may be converted into supplemental data table 365 entries in a manner similar to that described above with respect to base data table 230 generation. Further, base data table 230 entries may also be used to form one or more supplemental data table 365 entries, as shown by the block 360 labeled “Logic: SpDT/BDT_{1A}.” Supplemental data tables 365 are generally used on a case-by-case basis to generate custom reports 260. Generally, supplemental data tables may be thought of as base data tables 230 with a nonstandard layout. Such data tables contain entries not suited for the formatting of a standard base data table.

Data or information from the base data tables 230 is generally processed by fully custom or semi-custom code according to each client's unique cases and outputted in one or more summary data tables 240 (not shown in FIG. 3). In the present embodiment, summary data tables 240 are generated for four different program modules: net commissions 250; profit/loss 370; portfolio accounting/performance 380; and FLI reports 390. Each programming module 250, 370, 380, 390 may draw on any or all of the raw data tables 220, the base data tables 230, or the supplemental data tables 365 when creating a summary data table. Further, data may be shared between the program modules in the creation of summary data tables.

Each program module 250, 370, 380, 390 generally focuses on creating a different type or class of reports 260. For example, the net commissions program module 250 typically generates one or more reports permitting advisors and managers to access daily gross production. This may include such information as commissions paid to each representative, fees charged by each representative, fee discounts given to various clients by each representative, varying commissions for each type of product involved in a transaction (i.e., a 1% commission payable to the client for each mutual fund transaction, as opposed to a 0.5% commission paid to the same client for each individual stock transaction), discounts on a per product basis, special fees charged on a per product basis, and so on. As used in this document, “representative” generally means a broker, dealer, or other trader. By contrast, the portfolio accounting/performance module 380 generally generates performance reports 260 permitting advisors to accurately track and report a client's returns on various products and investments.

From the summary data tables 240 generated by each program module, a variety of reports 260 may be created. Many reports may be standardized and used by multiple clients, such as a report showing commissions earned by each broker employed by a client. Other reports 260 may be completely custom, such as a report for a client showing the total number of trades made in a certain equity after 12:00 p.m. every day. Still others may be a combination of the two, such as a broker commission report detailing incentives given by a client to its brokers for trades made in a particular security.

Additional Embodiments

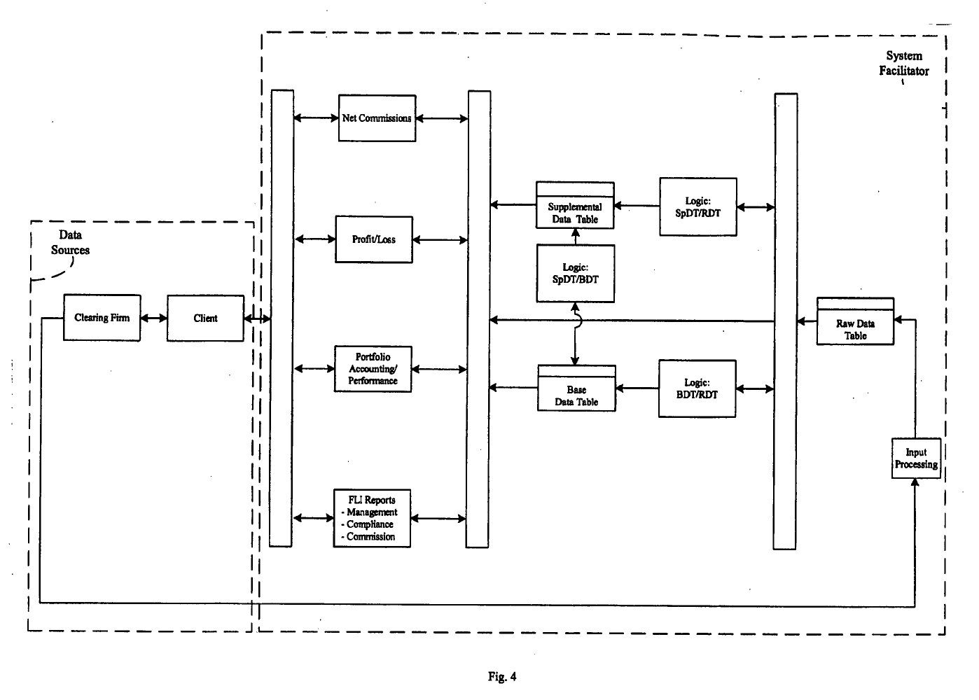

FIGS. 4-7 show additional embodiments of the present invention. Although a single data source 210 and raw data table 220 is shown in each of these figures for simplicity, it should be understood that any of the embodiments shown in FIGS. 4-7 may create multiple raw data tables from multiple data sources.

Turning now to FIG. 4, raw data received from the clearing firm 310 is processed and stored in a raw data table 220. This “processing” 340 may involve mere parsing of the raw data received from the data source 210 (i.e., the clearing firm 310 in FIG. 4), or it may involve more extensive manipulation or reformatting of the raw data. Subsequently, logic 350 pulls information from the raw data table (RDT) 220, manipulates it, and stores it in a base data table (BDT) 230. This logic is represented by the block “Logic: BDT/RDT” 350. A different logical operation 410 pulls data from the same RDT, manipulates it, and stores it as an entry in a separate supplemental data table (SpDT) 365. This latter logic is represented by the block “Logic: SpDT/RDT” 410. As shown by the block “Logic: SpDT/BDT” 360, information in the SpDT 365 may also be derived by further manipulating information in the BDT 230. The information in the SpDT 365, the BDT 230, and the RDT 220 is all made available to each of the program modules (net commissions 250, profit/loss 370, portfolio accounting/performance 380, and FLI reports 390) to create any possible reports requested by the client.

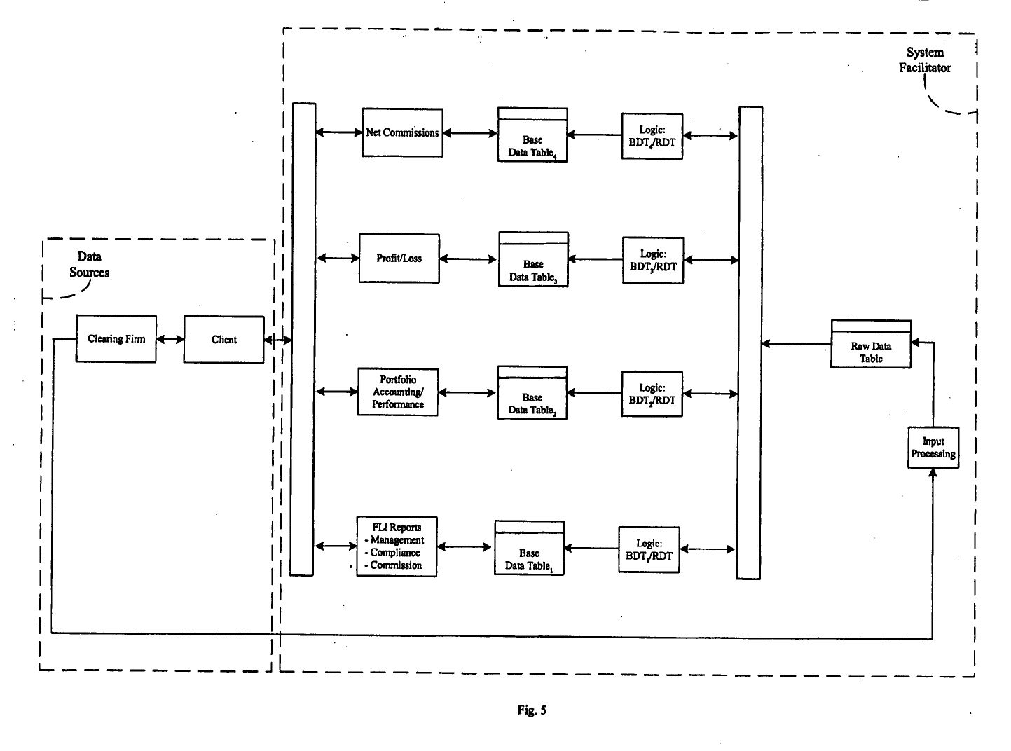

In FIG. 5, a Raw Data Table 220 is used to create four distinct base data tables 515, 525, 535, 545. In particular, a first logical operation 510 represented by the block “Logic: BDT₁/RDT,” pulls information from the Raw Data Table 220, manipulates it, and stores it as one or more entries in the first base data table (Base Data Table₁) 515. Similarly, a second logical operation 520, represented by the block “Logic: BDT₂/RDT,” pulls information from the Raw Data Table 220, manipulates it, and stores it as one or more entries in Base Data Table₂ 525. Similar operations are performed on the entries in the Raw Data Table 220 by logical operations 530, 540 to create entries in Base Data Table₃ 535 and Base Data Table₄ 545. Here, unlike the embodiment of FIG. 4, each program module 250, 370, 380, 390 has a single base data table (545, 535, 535, and 515, respectively) available. Accordingly, each set of reports 260 requested by a client 320 from a program module is generated from a unique base data table.

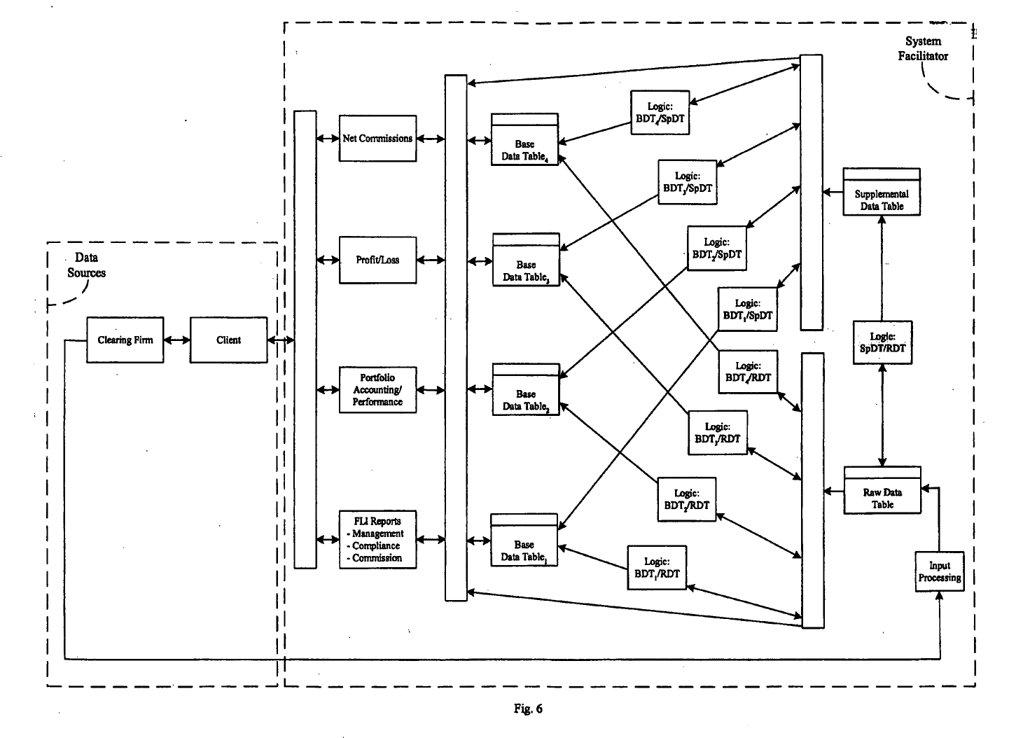

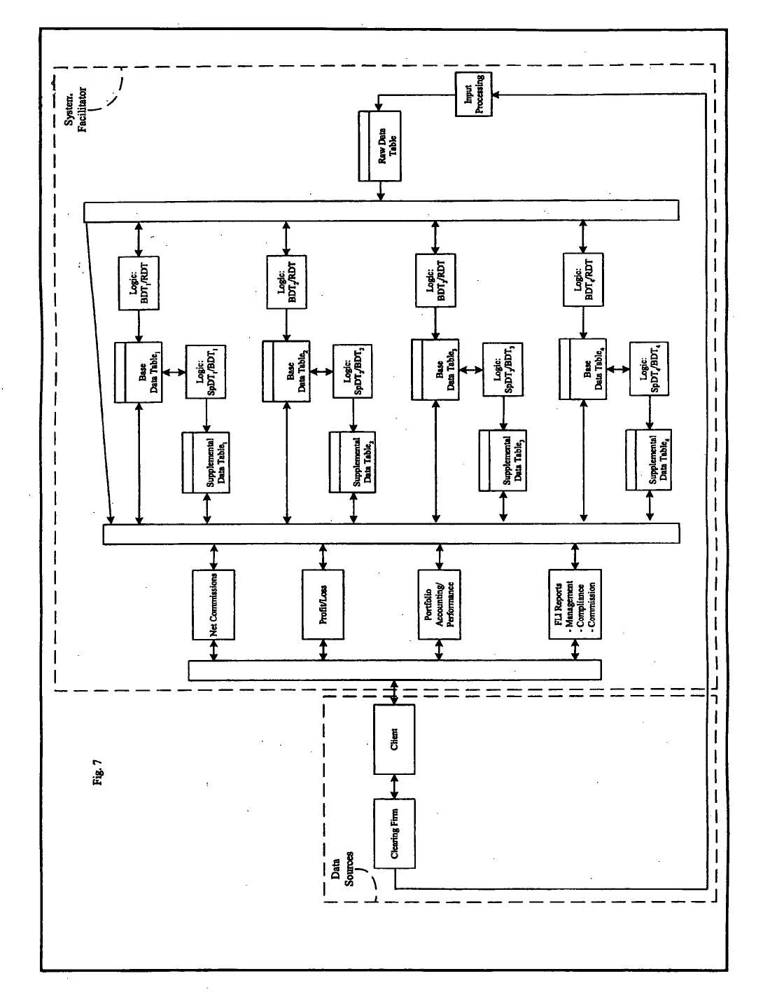

In FIG. 6, a Raw Data Table 220 is used to create multiple base data tables, namely Base Data Table₁ 615 through Base Data Table₄ 645. These Base Data Tables 615, 625, 635, 645 are at least partially created by logical operations operating on the Raw Data Table 220. The logical operations are represented by Blocks “Logic: BDT₁/RDT” 610, “Logic: BDT₂/RDT” 620, “Logic: BDT₃/RDT” 630, and “Logic: BDT₄/RDT” 640. In this embodiment, a Supplemental Data Table 365 is generated from the Raw Data Table 220 by a logical operation represented by the block “Logic: SpDT/RDT” 410. As with the generation of Base Data Table₁ 615 through Base Data Table₄ 645, the Supplemental Data Table 365 is generally created by extracting one or more entries from the Raw Data Table 220, formatting and manipulating the entries as necessary, and inserting the manipulated data as unique entries in the Supplemental Data Table. Base Data Table₁ through Base Data Table₄ may be created in this embodiment 600 by logically operating not only on the Raw Data Table 220 entries, but also on the Supplemental Data Table 365 entries. For example, logical operation “Logic: BDT,/SpDT” 650 extracts and possibly manipulates data from the Supplemental Data Table 365 to create one or more entries in Base Data Table 615. Logical operations 660, 670, 680 perform similar functions to create or manipulate entries in other Base Data Tables 625, 635, 645. Further, in this embodiment, each program module 250, 370, 380, 390 has access to the information contained not only within each of Base Data Table₁ 615 through Base Data Table₄ 645, but also the data stored within both the Supplemental Data Table 365 and the Raw Data Table 220. Thus, this embodiment 600 allows reports to be generated by each program module from information stored in any of Base Data Table₁ 615 through Base Data Table₄ 645, the Raw Data Table 220, or the Supplementary Data Table 365.

In the embodiment 700 of FIG. 7, a Raw Data Table 220 is again used to create multiple base data tables 710, 720, 730, 740, namely Base Data Table₁ 710 through Base Data Table₄ 740. In particular, each of these base data tables is created through logical operations 715, 725, 735, 745 pulling data from the Raw Data Table 220, manipulating it, and storing it in a corresponding base data table. The logical operations used to create each base data table and embodied in the various logic blocks may be identical or may be different. In this embodiment 700, four supplemental data tables 750, 760, 770, 780 are also created. Supplemental Data Table₁ 750 is generated by logic (“Logic: SpDT₁/BDT₁”) 755 operating upon information in Base Data Table₁ 710, Supplemental Data Table₂ 760 is generated by logic (“Logic: SpDT₂/BDT₂”) 765 operating on data in Base Data Table₂ 720, and so forth. The information in Base Data Table₁ 760 through Base Data Table₄ 740, Supplemental Data Table₁ 750 through Supplemental Data Table₄ 780, and the Raw Data Table 220 is made available to the four program modules (i.e., net commissions 250, profit/loss 370, portfolio accounting/performance 380, and FLI Reports 390) in order to create reports 260 requested by the client 320. This embodiment 700 again allows for reports generated by each of the program modules 250, 370, 380, 390 to be developed using information from any of the base data tables 710, 720, 730, 740 any of the supplemental data tables 750, 760, 770, 780, and the raw data table 220.

The Net Commission Processing Module

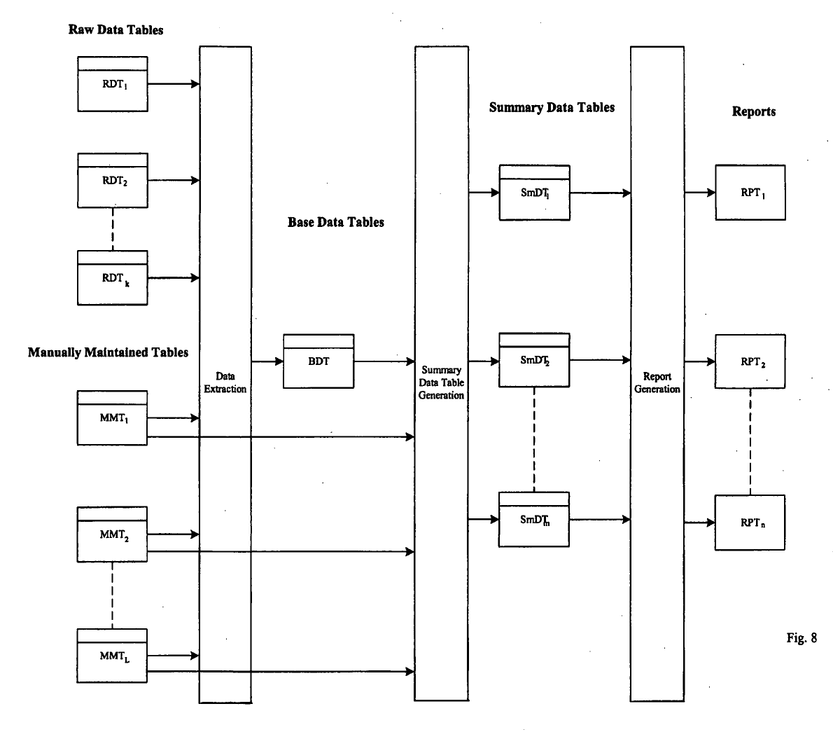

FIG. 8 displays a system level diagram of an overview of the net commissions module's 250 operation according to an embodiment of the present invention. Generally, the net commissions module 250 operates in an embodiment similar to that described with respect to FIGS. 4-7. Accordingly, the importation of data from data sources 210 is not shown. Similarly, for ease of viewing, no supplemental data tables 365 are shown. Pseudocode detailing the operation of the net commissions module 250 is given at the end of this specification in the section entitled “Exemplary Net Commission Pseudocode,” although it should be understood that the pseudocode is but one possible implementation of the net commission processing module.

Data may be extracted from raw data tables 220a, 220b, . . . 220k and from manually maintained tables 800a, 800b, . . . 800l, logically processed, and inputted into a base data table 230 as one or more entries. The logical processing 810 typically examines the entries in a raw data table 220 or manually maintained table 800 and reformats the data (if necessary) for entry into the base data table 230. Further, the logical processing operation 810 may compare two data entries from two data sources 210, which may or may not be stored in the same raw data table 220, and extrapolate a single base data table 230 entry therefrom.

For example, a client 320 may record a sale of an equity by a broker, logging the desired sale price, broker identification, broker's time of transaction, and commission, and assigning a transaction identifier. Any and all of these items may be present as an entry in a raw data table 220. Similarly, the clearing firm 310 processing the broker sale order may record the time the order was placed, the time the order was filled, assign a different transaction identifier, record the actual sale price, and also assign the transaction to a group of similar sales. Again, these items may also be present in a raw data table 220. The logical operation 810 may match the time the order was placed against the broker's time of transaction, determine that all entries associated with the placement time constitute data regarding the clearing firm's 310 side of the sell transaction, and determine that all entries associated with the broker's time of transaction constitute data regarding the client's 320 side of the same sell transaction. These two data groups may then be synthesized into a single, more complete entry or set of entries in the base data table 230. Further, because all data is retained in the raw data tables 220a, 220b, . . . 220k, the integrity of any transaction or logical operation 810 may easily be later verified.

FIG. 8 displays a single base data table 230. In this embodiment of the net commissions module 250, data is typically combined from multiple raw data tables 220a, 220b, . . . 220k into one base data table 230. Other modules 370, 380, 390 and alternate embodiments of the net commissions module may employ more than one base data table 230. A sample base data table (in this case, T_BILLING) is given in Appendix A. Definitions for the various values comprising each data entry may be seen in Appendix D.

Entries may be extracted from either the base data table 230 or from the manually maintained tables 800a, 800b, . . . 800l and manipulated to form one or more summary data tables (SmDTs) 240a, 240b, . . . 240m. The exact manipulations 820 performed on data taken from the base data table 230 and manually maintained tables 800a, 800b, . . . 800l vary depending on each client's unique cases. Examples of specific manipulation of data to generate a summary data table 240 are given below with respect to FIGS. 15-17.

Generally, a summary data table 240 stores data in a final format suitable for generating one or more reports 260. As with other data tables mentioned herein, summary data tables are typically comprised of SQL database entries. Other table and/or database formats may be used by alternate embodiments. The entries in a summary data table 240 have typically been fully processed in order to meet a client's unique case. Accordingly, reports 260a, 260b, . . . 260n may be quickly generated by pulling finalized data from one or more summary data tables 240a, 240b, . . . 240m, arranging the data as desired by the client 320 (a procedure represented in FIG. 8 by the “report generation” block 830), formatting, and transmitting the report. Report transmission may be via any acceptable network or may simply involve displaying a report 260 on an appropriate local display device, such as a monitor, television, web tablet, or printer.

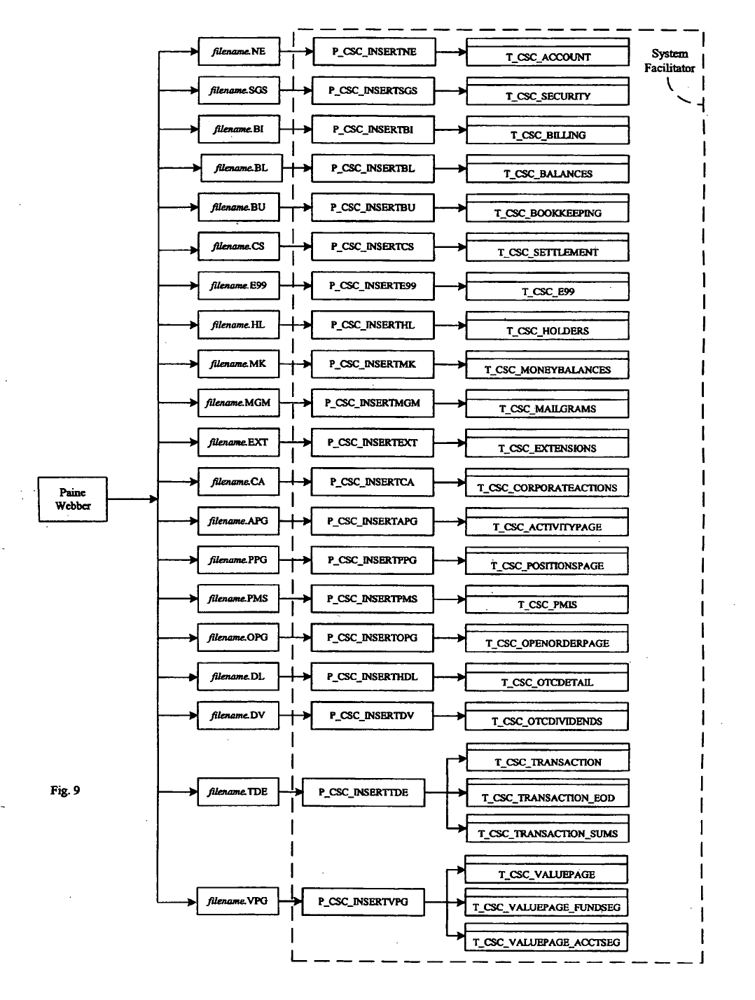

FIG. 9 displays one example of a method for importing data from a data source 210 and storing the data in a series of raw data tables 220. In the example shown in FIG. 9, a system facilitator 330 receives multiple files from a clearing firm 310, in this case Paine Webber 900. As shown, Paine Webber 900 generally transmits twenty separate files 910a, 910b, . . . 910t to the system facilitator, each with a different filename extension. The facilitator 330 may extract data from the files through a series of logical operations 920a, 920b, . . . 920t. Each logical operation is designed to obtain data from a specific file type and place the data as a database entry in one or more raw data tables 930a, 930b, . . . 930x. Further, the logical operations may reformat data, if necessary.

For example, the system facilitator 330 may receive a file 910n with a .PPG extension. The corresponding logical operation 920n (in this case, P_CSC_INSERTPPG) extracts all data from the .PPG file 910n, reformats it if necessary, converts each datum into an SQL database entry, and stores the entries in the T_CSC_POSITIONSPAGE raw data table 930n.

Generally, logical operations 920a, 920b, . . . 920t may look for two different types of data. Some files 910a, 910b, . . . 910t may contain new data every time the file is transmitted. In this case, the logical operation 920 dealing with the file simply exports all data and converts it to raw data table entries. Other files 910a, 910b, . . . 910t may contain only data that has changed since the last file transmission. Here, a logical operation 920 may examine the data, determine the corresponding entry in the raw data table 930a, 930b, . . . 930x containing old data, and replace the old entry with the changed data.

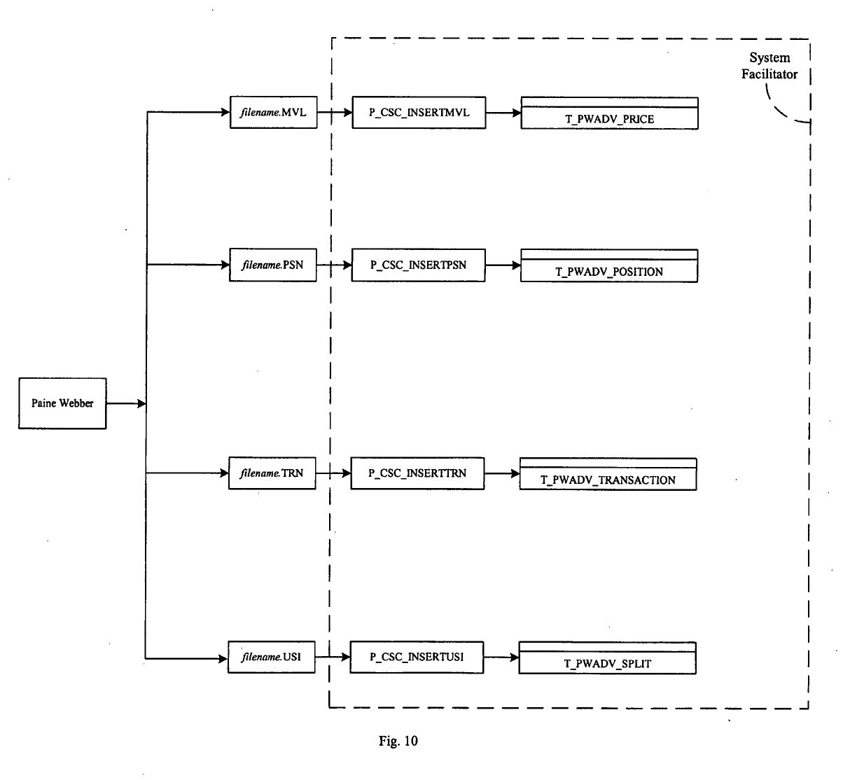

Further, some files 910a, 910b, . . . 910t may contain data imported into multiple raw data tables. For example, the .TDE file 910s shown in FIG. 9 contains data that may be extracted by the P_CSC_INSERTTDE logical operation 920s and inserted into three raw data tables: T_CSC_TRANSACTION 930s, T_CSC_TRANSACTION_EOD 930w, and T_CSCTRANSACTION_SUMS 930x. The general formatting of the files shown in FIG. 9, and type of data contained therein, is given in Paine Webber's “Paine Webber/CSC Raw Data File Record Layouts” book, dated Jul. 21, 2000 and available from Paine Webber. The entirety of this book is hereby incorporated by reference as if fully set forth herein. Additional Paine Webber/CSC 900 data files 1010a, 1010b, 1010c, 1010d and logical operations 1020a, 1020b, 1020c, 1020d for converting data contained therein into entries in raw data tables 1030a, 1030b, 1030c, 1030d are shown in FIG. 10.

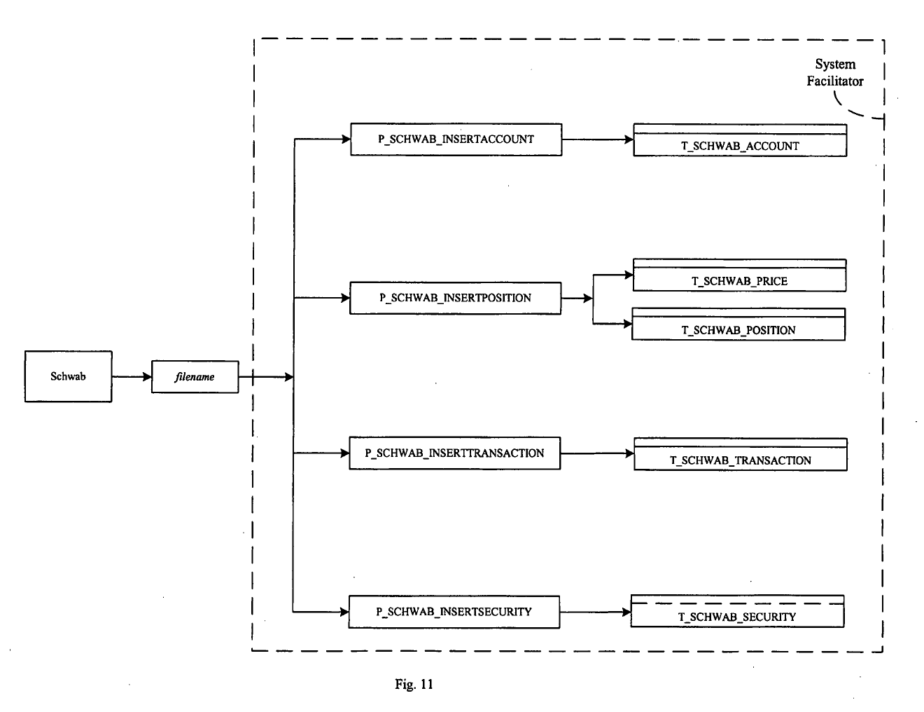

Alternate data sources may have different file and data formats. For example, Schwab Institutional file and data formats are described in the “SchwabLink v2.1 Developer's Manual,” dated Apr. 7, 2000 and hereby incorporated by reference as if fully set forth herein. An example of one data import methodology for Schwab Institutional 1100 is shown in FIG. 11. Generally, one or more logical operations 1120a, 1120b, 1120c, 1120d extract and/or manipulate data in the file 1110 to create one or more raw data tables 1130a, 1130b, 1130c, 1130d, 1130e.

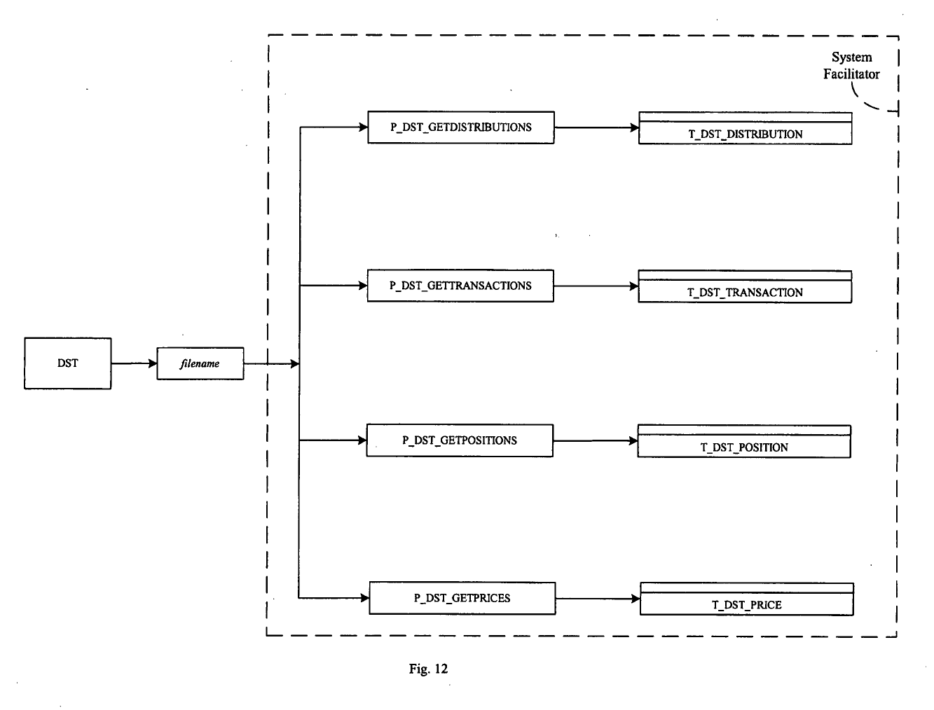

DST 1200, another potential data source 210, sets out its file and data formats in the “DST FAN Mail Technical Manual,” dated Mar. 28, 2000. This manual is also hereby incorporated by reference as if fully set forth herein. An exemplary DST file 1210, logical operations dealing with the file 1220a, 1220b, 1220c, 1220d, and resulting raw data tables 1239a, 1230b, 1230c, 1230d are shown in FIG. 12.

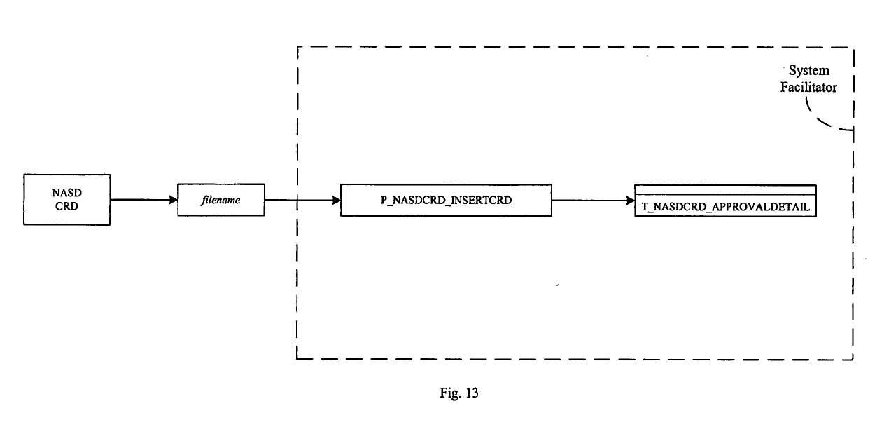

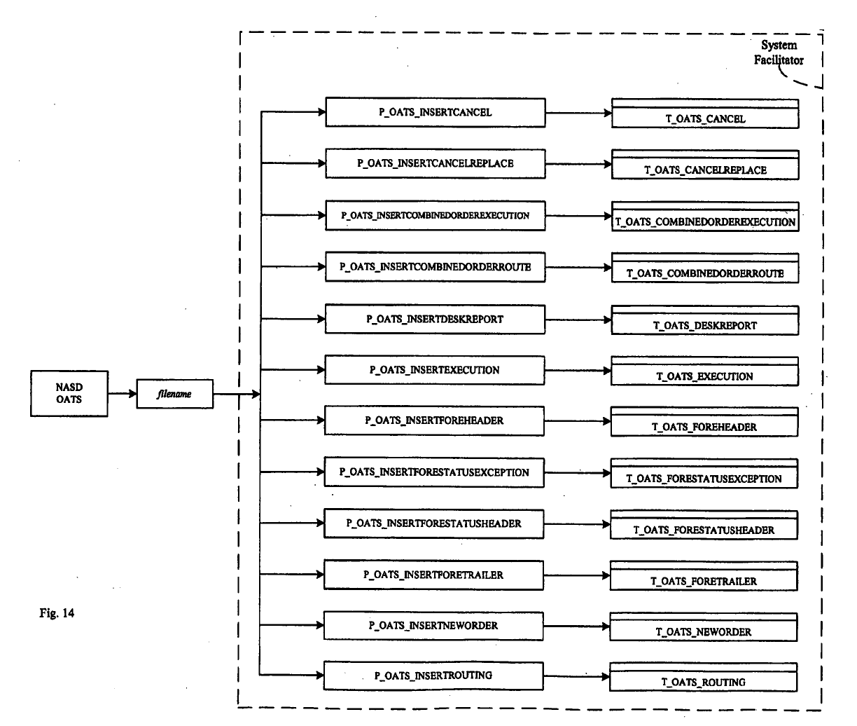

Finally, the National Association of Securities Dealers (NASD) may also act as a data source through either its Central Registration Depository (CRD) system 1300 or its Order Audit Trail System (OATS) 1400. NASD's CRD data file 1310 formats are given in the “NASD CRD Report Specifications Document,” dated Aug. 9, 2002 and available from NASD. Similarly, OATS data and file 1410 formats are described in the “NASD OATS Reporting Technical Specifications Document,” dated Oct. 29, 2001, also available from NASD. Both documents are hereby incorporated into this specification by reference as if fully set forth herein. FIG. 13 displays a method for importing data from NASD CRD 1300 files 1310 into a raw data table 1330, through logical operation 1320, in accordance with an embodiment of the present invention. Similarly, FIG. 14 displays an exemplary method for importing data from a NASD OATS 1400 file 1410. Multiple raw data tables 1430a, 1430b, . . . 1430l may be created from the data in the file 1410 by one or more logical operations 1420a, 1420b, . . . 1420l.

FIG. 15 is a flow diagram displaying a method 1500 for creating summary data tables 1530, 1540 from raw data tables and manually maintained data tables in a net commissions processing module 250, in accordance with an embodiment of the present invention. This flow diagram specifically pertains to reporting information provided by Schwab Institutional 1100 (see also FIG. 11) and Paine Webber 900 (see also FIG. 9).

Initially, data is extracted by logical operation 1510 from raw data tables T_CSC_BILLING 930c, containing information provided by Paine Webber, and T_SCHWAB_TRANSACTION 1130d, containing information provided by Schwab Institutional 1100, to create the base data table T_COMM_DETAIL 1520. Although only two raw data tables 930c, 1130d are shown undergoing data extraction 1510, it should be understood that other raw data tables 220 may also be processed in this manner depending on the data source 210 providing data.

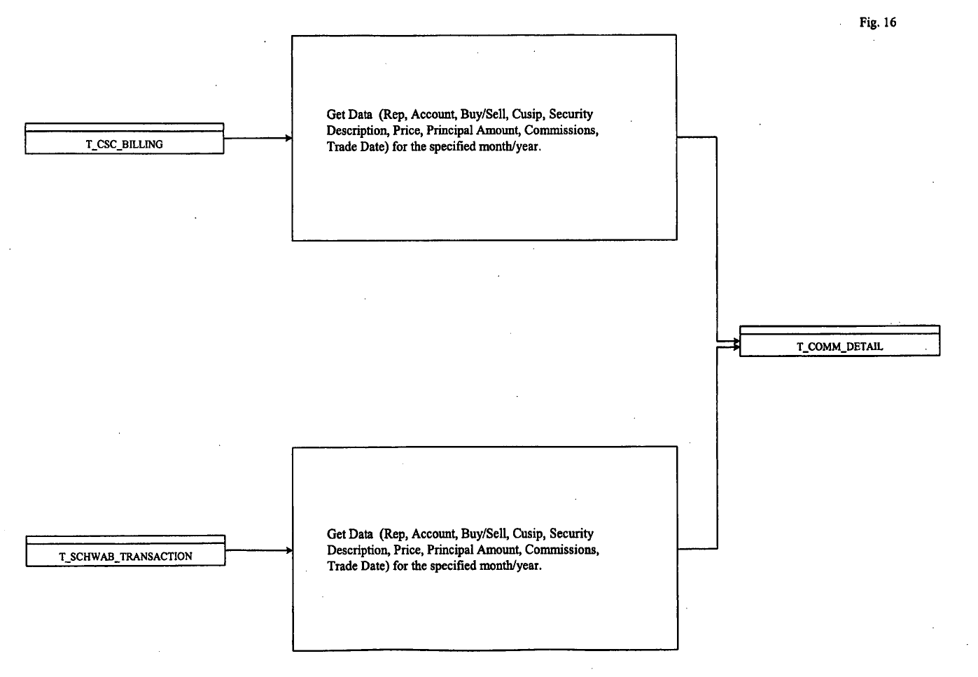

FIG. 16 displays the data extraction process 1510 in greater detail. The embodiment retrieves a data set for a given transaction from both the T_CSC_BILLING 930c and T_SCHWAB_TRANSACTION 1130d raw data tables via the “get data” operations 1600, 1610. This data set consists of the following entries:

“Rep,” which identifies the broker or entity placing a transaction;

“Account,” containing the account number associated with the transaction;

“Buy/Sell,” indicating whether the transaction is a purchase or sale;

“CUSIP,” which contains the Committee on Uniform Security Identification Procedures number identifying the security being bought or sold;

“Security Description,” a text description of each security (i.e., “International Business Machines” for IBM stock, or “International Business Machines March 25 Put 22 2/3” for an IBM option);

“Price,” or the price at which the security was traded;

“Principal Amount,” indicating the total amount paid for the transaction (that is, the security price times the number of securities transacted);

“Commissions,” containing the commission charged by the broker or client;

and “Trade Date,” delineating the date and time at which the transaction occurred.

Once this data is retrieved or extracted by logical operations 1600, 1610, this embodiment creates a single entry in the T_COMM_DETAIL base data table 1520 containing all the above information. Of course, alternate embodiments may create multiple entries in one or more base data tables containing the data based upon data from the raw data tables 930c, 1130d. For example, an alternate embodiment might create two base data table 230 records from the raw data: one including all security-related information (CUSIP, Security Description, Price, Principal Amount) and one for non-security information (Rep, Account, Buy/Sell, Commissions, and Trade Date).

In the present embodiment, a user may specify a month and year for which a report 260 is desired. The embodiment then retrieves all data listed above for that time period from the raw data tables 930c, 1130d and populates the T_COMM_DETAIL base data table 1520 with records only for the desired time.

Returning again to FIG. 15, a set of manually maintained tables (generally, with respect to this Figure, 1550) may also be created from manual data entry. The manually maintained tables are: T_COMM_GROSSPAYOUT 1550a; T_COMM_FEESCHEDULE 1550b; T_COMM_COMMISSIONDISCOUNTING 1550c; T_COMM_FEEDISCOUNTING 1550d; T_COMM_ACCOUNTPAYOUT 1550e; T_COMM_PRODUCTPAYOUT 1550f; T_COMM_OVERRIDE 1550g; T_COMM_ADJUSTGROSSPERIODIC 1550h; T_COMM_ADJUSTGROSSINGLE 1550i; T_COMM_ADJUSTNETPERIODIC 1550j; and T_COMM_ADJUSTNETSINGLE 1550k. A description of each manually maintained table, its function, and examples of the data stored therein follows.

The T_COMM_GROSSPAYOUT table 1550a typically contains three values per entry, namely, Starting Value, Ending Value, and Payout %. A range of values is given to detail a payout grid. The table below provides an example. In this example, a broker will earn 50% of the commissions he makes if he makes between $0 and $15,999.99 in commissions, but the broker will earn 60% of those commissions if the broker makes $16,000.00 or more in a month.

| Starting Value | Ending Value | Payout % |
|---|---|---|
| 0.0 | 15999.99 | 0.5 |
| 16000.00 | 999999.99 | 0.6 |

The T_COMM_FEESCHEDULE manually maintained table 1550b has five values per entry: Product Type, Fixed Fee, Variable Fee, Minimum, and Maximum. This table give a fee structure charged to the broker by product type. Fees may be fixed or variable, with minimum or maximum dollar values for commissions. Exemplary data entries are given in the following table.

| Product Type | Fixed Fee | Variable Fee | Minimum | Maximum |
|---|---|---|---|---|
| Mutual Funds | 13.0 | 0 | −999999 | 9999999 |
| Listed-Customer | 13 | 0.0025 | −999999 | 9999999 |
| Listed-Execution | 0 | 0.0025 | −999999 | 9999999 |
| Options | 13 | 0.7 | −999999 | 9999999 |
| Principal | 21 | 0 | −999999 | 9999999 |
| Tax Lot Sales | 0 | 0 | −999999 | 9999999 |

The T_COMM_COMMISSIONDISCOUNTING table 1550c generally contains three values per data entry. These values are Product Type, Amount, and Fee. This table allows for the discounting of charged commissions per product type if the commission amount is over a certain amount. A sample T_COMM_COMMISSIONDISCOUNTING table 1550c with two data entries follows.

| Product Type | Amount | Fee |
|---|---|---|
| Mutual Funds | 9999.99 | 5 |
| Options | 15000.00 | 7.50 |

The T_COMM FEEDISCOUNTING table 1550d includes three values: Product Type, Amount, and Fee. This manually maintained table permits a client or user to discount fees as desired. That is, when the fee for a product type exceeds a certain amount, the fee given in the “Fee” value may be charged instead of a standard fee.

| Product Type | Amount | Fee |
|---|---|---|
| Mutual Funds | 9999.99 | 0.05 |
| Options | 15000.00 | 0.125 |

The T_COMM_ACCOUNTPAYOUT manually maintained table 1550e has three values per entry, namely, Account, Percent, and Credit. This table allows for special payouts on individual accounts by either a percent of commissions or a specific value, or credit. An exemplary table 1550e follows.

| Account | Percent | Credit |
|---|---|---|
| FL12345 | 0.05 | 0.0 |
| FL99999 | 0.0 | 5.25 |

The T_COMM_PRODUCTPAYOUT table 1550f may have four values: Product Type, Starting Value, Ending Value, and Payout %. This manually maintained table contains data detailing special payouts on product accounts, made by varying by the amount of the product bought/sold.

| Type | Starting Value | Ending Value | Payout % |
|---|---|---|---|
| Wrap Fees | −99999 | 999999999 | 0.85 |

The T_COMM_OVERRIDE table 1550g includes four values per entry. These values are Debit Rep, Credit Rep, Percent, and Fixed. This table contains entries permitting one or more representatives to be credited with commissions from one or more other representatives. A common use is to implement split commissions between representatives. For instance, in the sample table below, representative A1 and representative A2 each receive a percentage of representative A3's commissions.

| Debit Rep | Credit Rep | Percent | Fixed |
|---|---|---|---|
| A3 | A1 | 0.4 | 0 |
| A3 | A2 | 0.6 | 0 |

The T_COMM_ADJUSTGROSSPERIODIC table 1550k handles periodic gross adjustments. Periodic gross adjustments are manually entered transactions that occur every month for a specified representative. This manually maintained table includes the following values for each entry: Account, Buy/Sell, Cusip, Price, Principal, Gross, Product Type, Date, and Descr. The values in this table are typically will be transferred into the T_COMM_DETAIL summary data table 1530 (discussed below) as a transaction. Gross adjustments are added to the T_COMM_DETAIL summary data table 1530 before net commission processing is finalized.

| | Buy/ | | | | | Product | | |
|---|---|---|---|---|---|---|---|---|
| Account | Sell | Cusip | Price | Principal | Gross | Type | Date | Descr |
| FL12345 | Buy | 012345678 | 12.50 | 1250.00 | 125.00 | Mutual | Jan. 1, 2001 | Off |
| | | | | | | Fund | | board |

Manually maintained table T_COMM_ADJUSTGROSSSINGLE 1550i generally contains the following values: Account, Buy/Sell, Cusip, Price, Principal, Gross, Product Type, Date, and Descr. This table 1550i stores single gross adjustments, which are basically manually entered transactions that will occur just once, on the specified date and for the specified representative. The other values in this table are values that will be transferred into a summary data table as a transaction. Gross adjustments are added to the trade blotter (i.e., the summary data table) before the processing of commissions takes place. A sample table follows.

| Account | Buy/Sell | Cusip | Price | Principal | Gross | Product Type | Date | Descr |
|---|---|---|---|---|---|---|---|---|
| FL12345 | Buy | 012345678 | 12.50 | 1250.00 | 125.00 | Mutual Fund | Jan. 1, 2001 | Off board |

The T_COMM_ADJUSTNETPERIODIC manually maintained table 1550j stores periodic net adjustments, and typically has six values per entry. These values are Rep, Starting Month, Starting Year, Amount, Description, and Type. A periodic net adjustment is a manually entered adjustment that recurs every month for a specified representative. The other values in this table are transferred into the T_COMM_DETAIL summary data table 1530 (discussed below) as a transaction associated with the adjustment. Periodic net adjustments are added to trade blotter (i.e., T_COMM_DETAIL) after the processing of commissions takes place.

| Rep | Starting Month | Starting Year | Amount | Description | Type |
|---|---|---|---|---|---|
| A1 | 1 | 2002 | 575.00 | Rent | RENT |

Finally, the T_COMM_ADJUSTNETSINGLE table 1550j generally has six values per data entry. These values are Rep, Month, Year, Amount, Description, and Type. Single net adjustments, stored in this manually maintained table, are manually entered adjustments that occur once, during the specified month, for the specified representative. The other values in this table are transferred into the T_COMM_DETAIL summary data table 1530 as a transaction comprising the net adjustment. Net adjustments are added to the trade blotter (T_COMM_DETAIL) after the processing of commissions takes place.

| Rep | Month | Year | Amount | Description | Type |
|---|---|---|---|---|---|
| A2 | 5 | 2002 | 59.67 | Car Service | CRSV |

The manually maintained tables 1550, along with the base data table 1520, are used to generate the summary data tables T_COMM_DETAIL 1530 and T_COMM_NETPAYABLE 1540. Some details regarding the generation of summary data tables 1530, 1540 from the manually maintained tables 1550 were briefly given above, with reference to the manually maintained table descriptions. Summary data table generation by a logical operation 1560 is accomplished by the embodiment in the following manner.

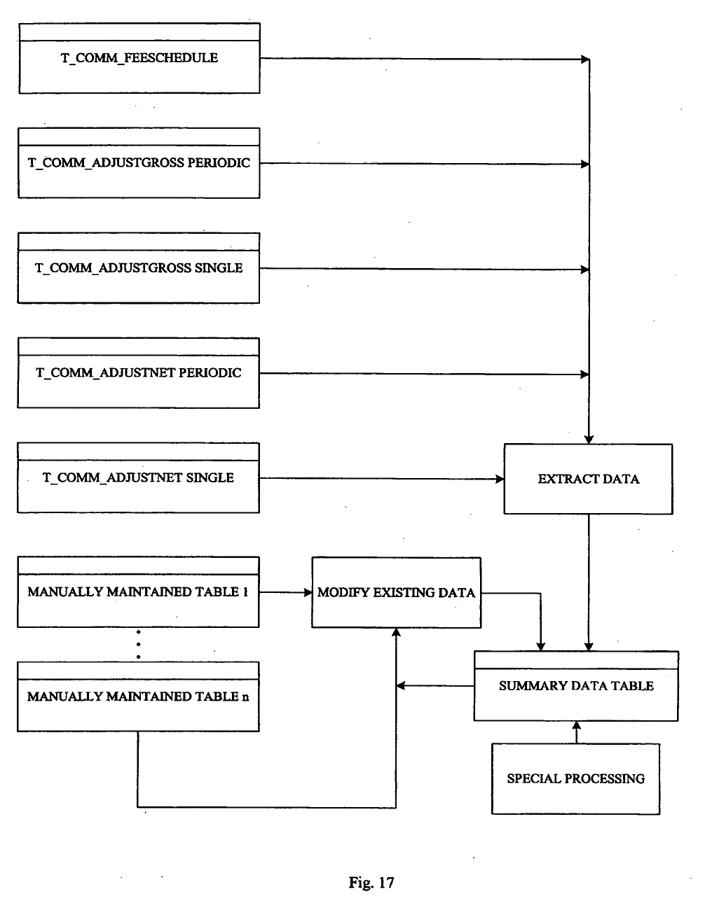

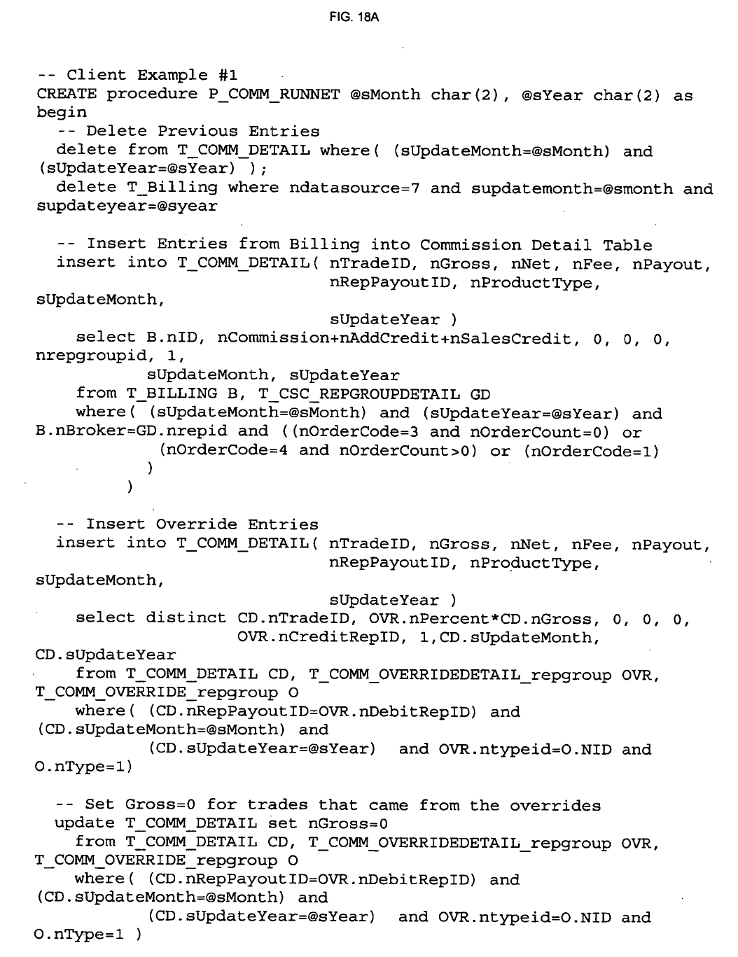

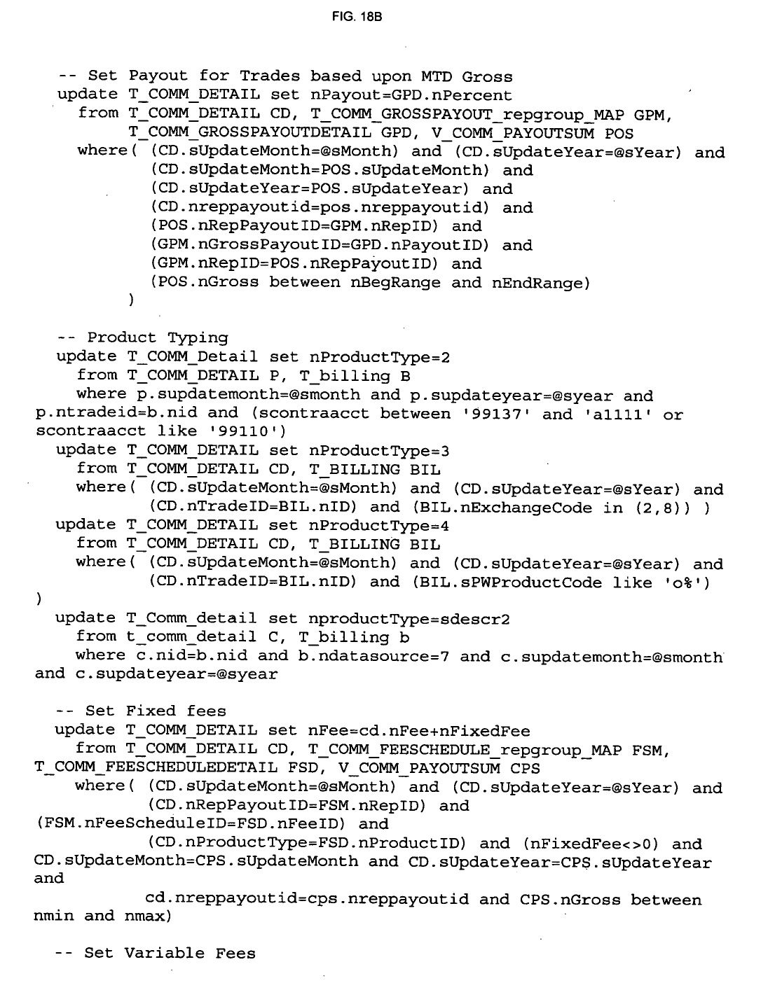

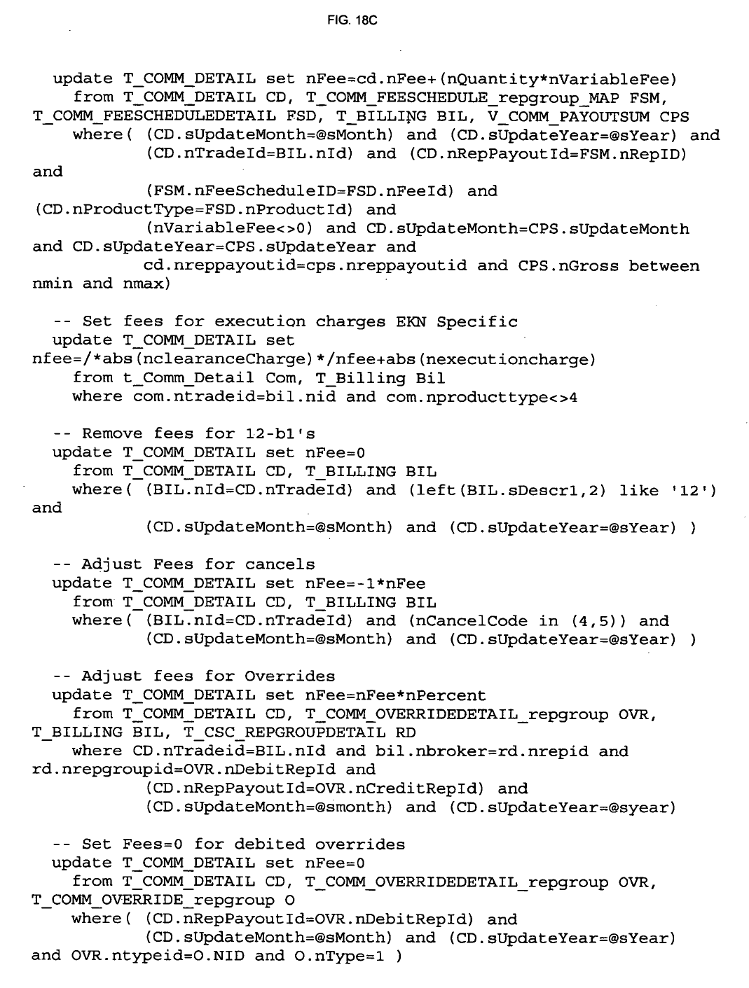

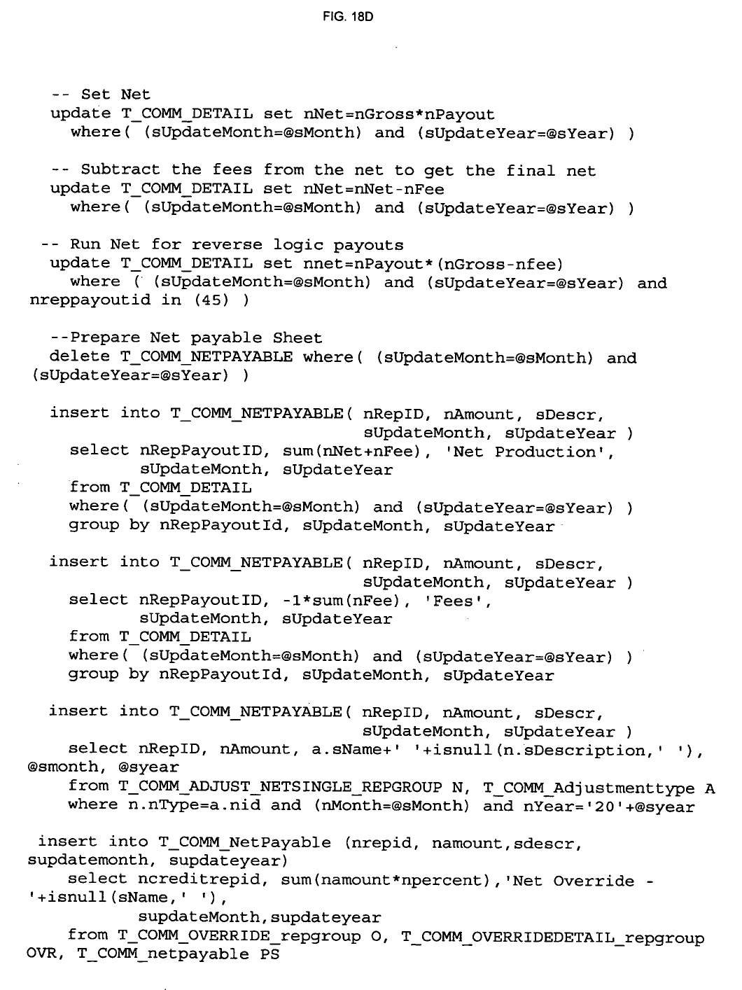

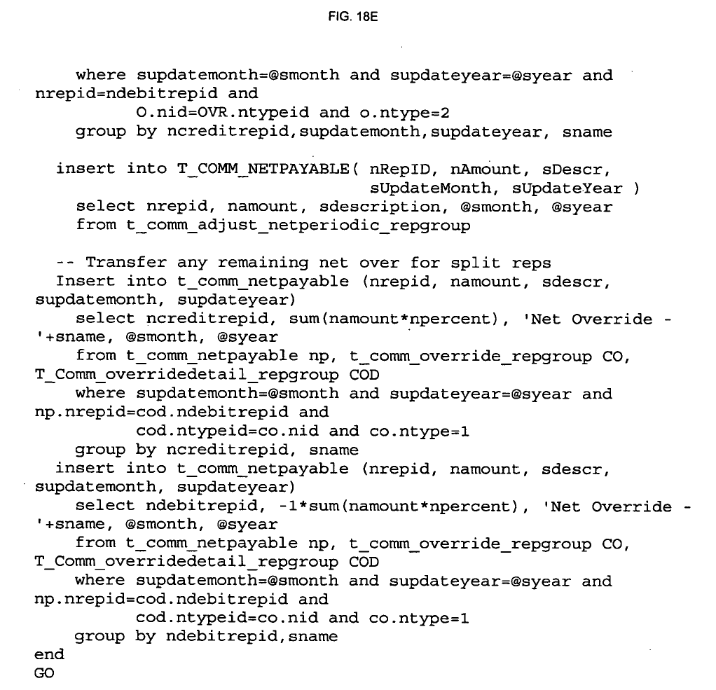

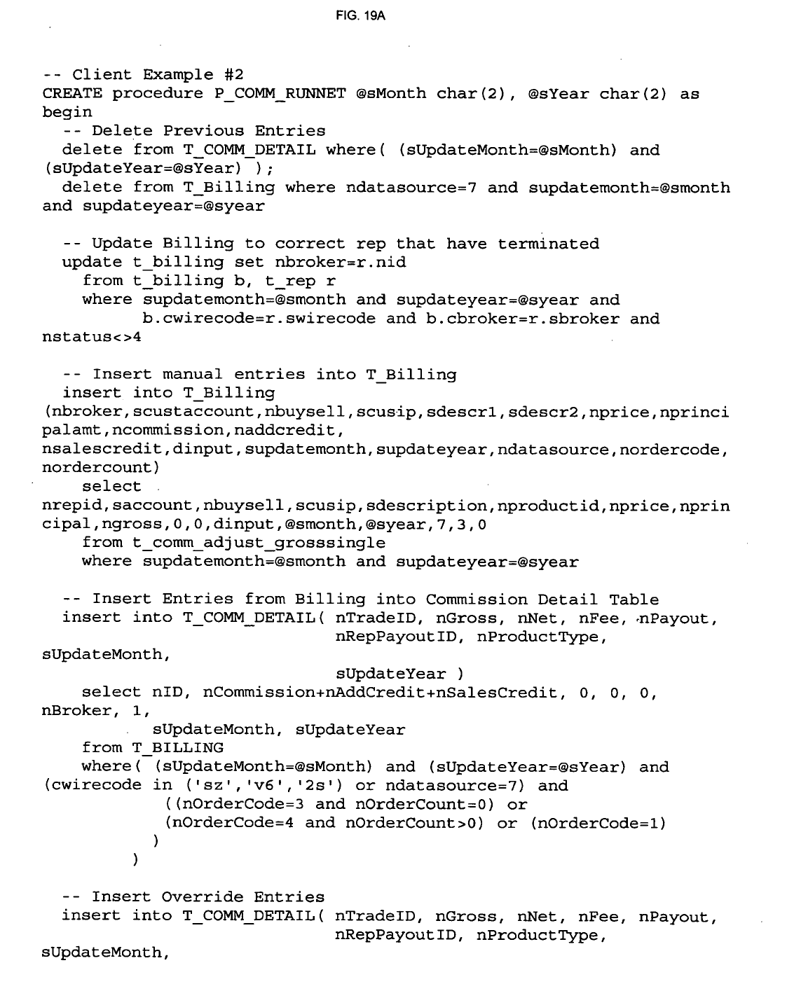

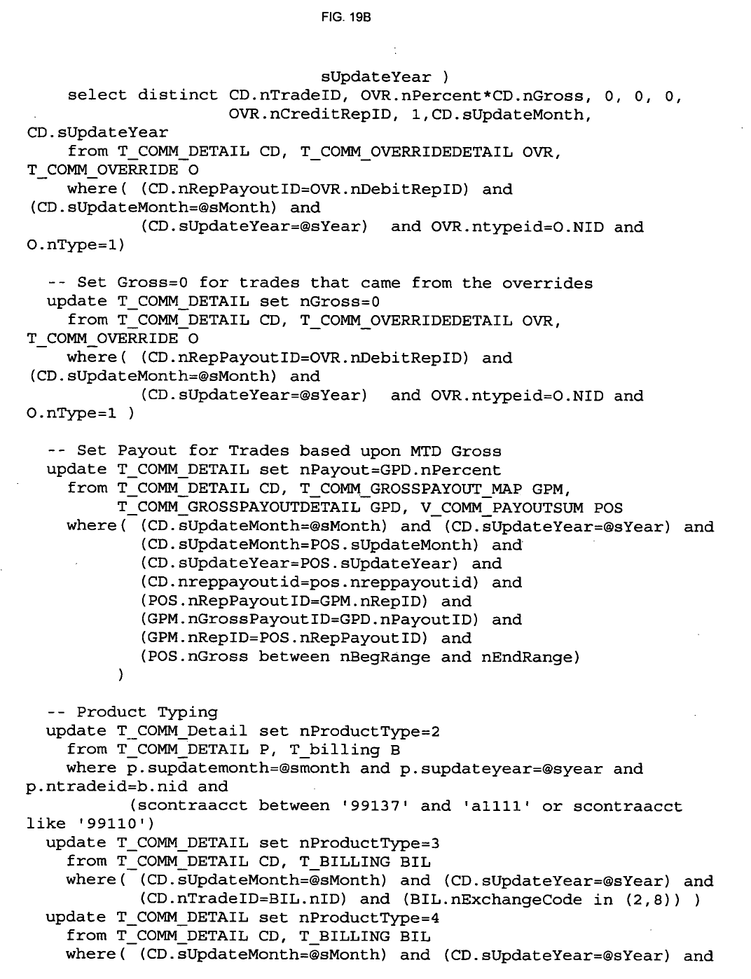

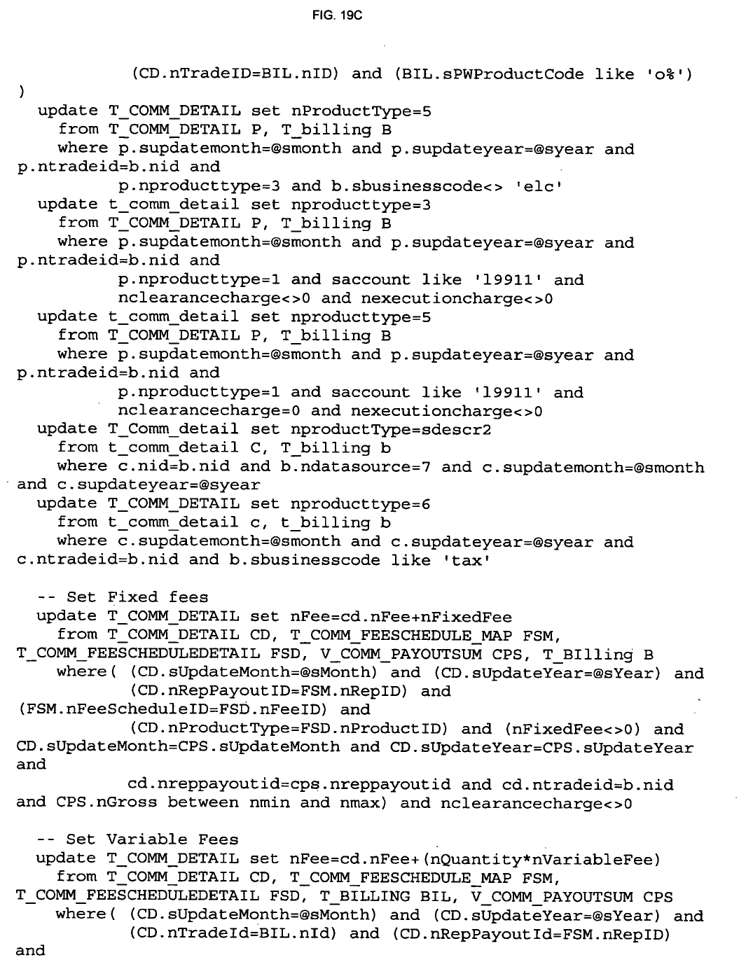

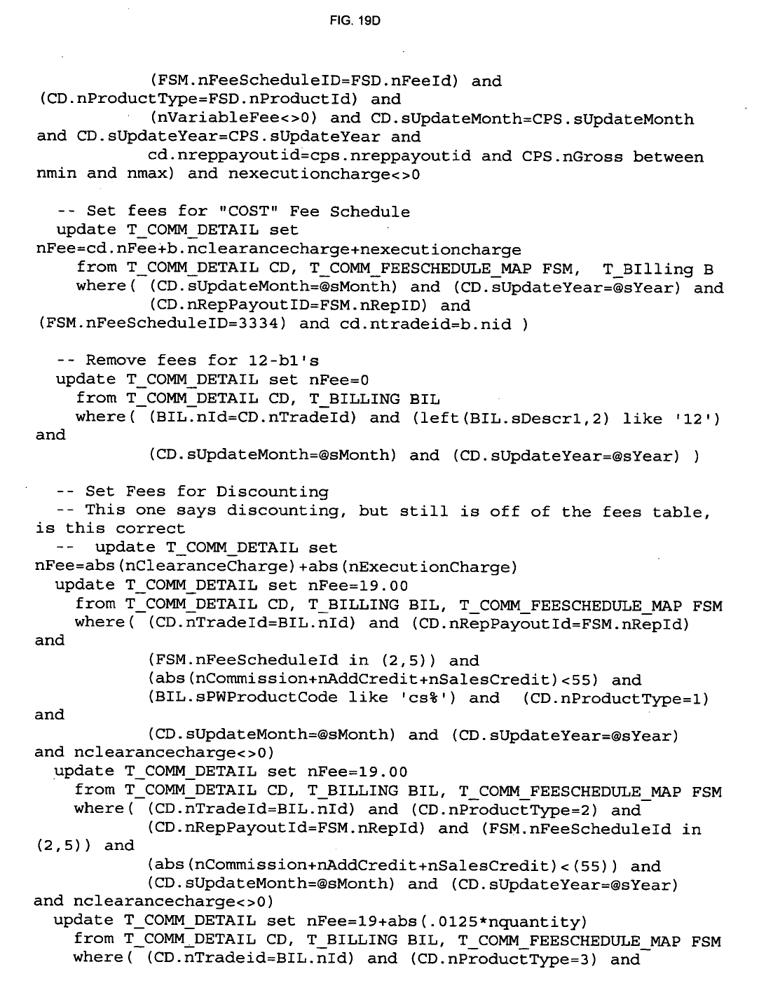

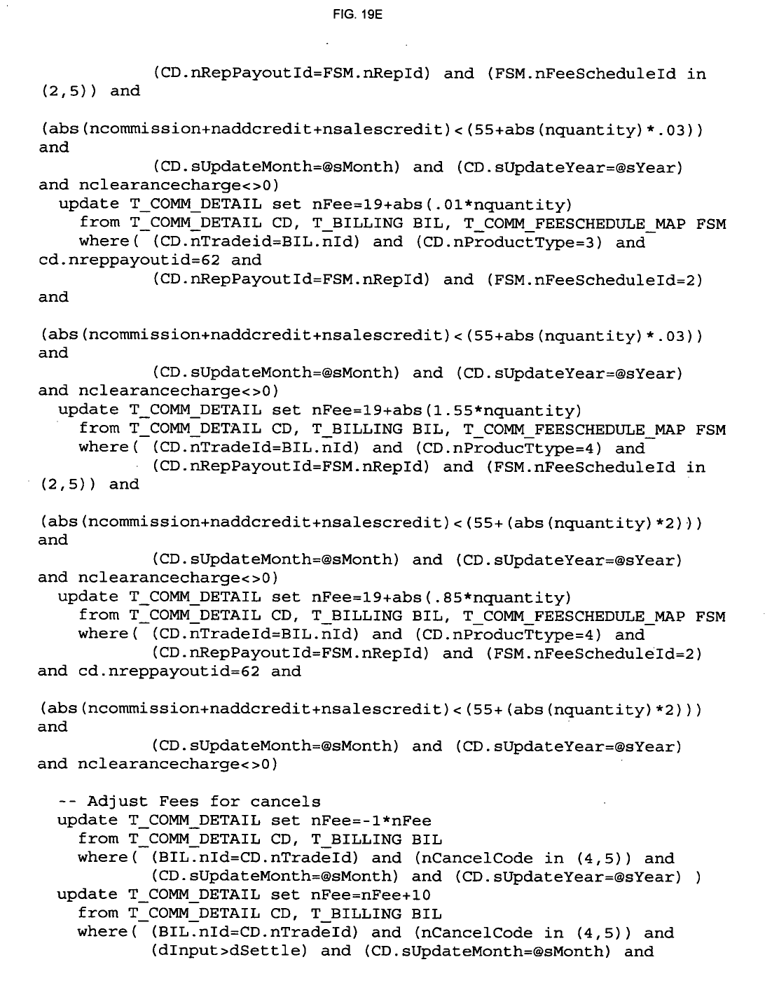

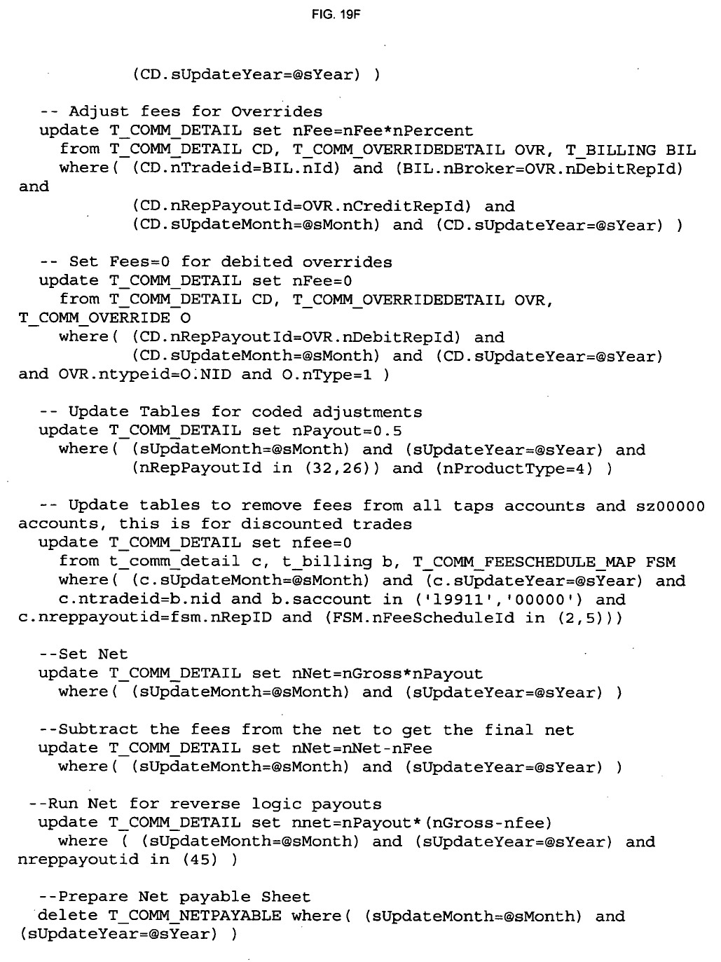

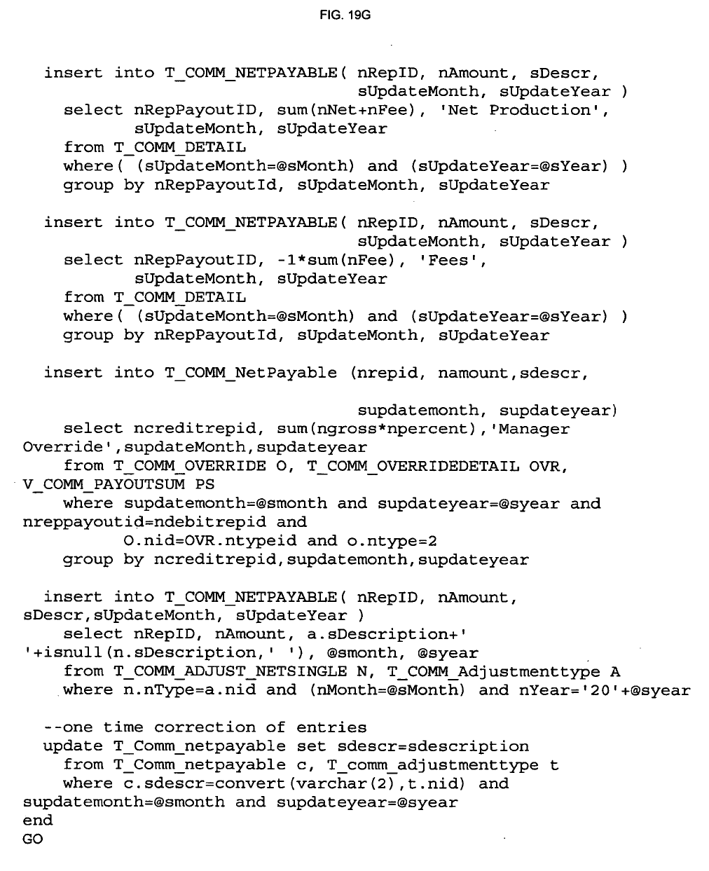

This processing phase 1560 generally entails three main parts, as shown in FIG. 17. First, data is transferred by operation 1710 from some of the manually maintained tables to the summary data table(s) 1720. The summary data table 1720 of FIG. 17 may represent either the T_COMM_DETAIL 1530 or T_COMM_NETPAYABLE 1540 tables of FIG. 15, or in alternative embodiments may represent a unique summary data table 240. Specifically, data is extracted from the T_COMM_FEESCHEDULE 1550b, T_COMM_ADJUSTGROSSPERIODIC 1550h, T_COMM_ADJUSTGROSSINGLE 1550i, T_COMM_ADJUSTNETPERIODIC 1550j, and T_COMM_ADJUSTNETSINGLE 1550k tables. Next, the data in the remaining manually maintained tables is used (here generally shown as 1700a through 1700n, which may correspond to any or all of tables 1550a through 1550k of FIG. 15, or may be unique tables) along with information from the summary data tables themselves, to modify existing data in the summary data tables 1720. This is represented on FIG. 17 by logical operation 1730, namely the black labeled “Modify Existing Data.” Finally, special processing 1740 is implemented on a case-by-case basis to meet each client's unique needs. The special processing step 1740 typically draws on data in the base data table 1520. Because unique needs vary on a client basis, the special processing step 1740 may vary widely. Examples of special processing are given in FIGS. 18A-E and FIGS. 19A-G.

A sample T_COMM_DETAIL summary data table 1530 is shown in Appendix B, and a sample T_COMM_NETPAYABLE summary data table 1540 is given in Appendix C. In keeping with the present example, these summary data tables 1530, 1540 are generated from the sample base table 1520 (given in Appendix A) by the special processing 1740 shown in FIGS. 18A-E and FIGS. 19A-G. Definitions for the values of the summary data tables are given in Appendix D.

Conclusion

As will be recognized by those skilled in the art from the foregoing description of example embodiments of the invention, numerous variations on the described embodiments may be made without departing from the spirit and scope of the invention. For example, different database structures may be used for any of the tables described above, or reports may be easily and quickly created in multiple formats not listed herein. Further, while the present invention has been described in the context of specific embodiments and processes, such descriptions are by way of example and not limitation. Accordingly, the proper scope of the present invention is specified by the following claims and not by the preceding examples.

```
    Exemplary Net Commission Pseudocode
    -----------------------
    -- Insert Processing --
    -----------------------
    -- Remove Previous Entries
    delete from T_COMM_DETAIL where (month=ThisMonth) and
(year=ThisYear)
    -- Insert entries from the T_CSC_BILLING table
    insert into T_COMM_DETAIL
      entries from T_BILLING where (month=ThisMonth)
      and (year=ThisYear)
    insert into T_COMM_DETAIL
      entries from T_COMM_OVERRIDE and T_{—}
      COMM_OVERRIDEDETAIL
where where (month=ThisMonth) and (year=ThisYear)
    -----------------------
    -- Update Processing --
    -----------------------
    -- Set Payout percentages
    update T_COMM_DETAIL set
nPayout=T_COMM_GROSSPAYOUTDETAIL.nPercent
      for each Rep for each Entry
    -- Set product types
    update T_COMM_DETAIL set ProductType=2
      where (month=ThisMonth) and (year=ThisYear) and
          (ContraAccount between ‘99137’ and ‘a1111’) or
(ContraAccount=‘99110’)
    update T_COMM_DETAIL set ProductType=3
      where (month=ThisMonth) and (year=ThisYear) and
          (ExchangeCode=‘2’ or ‘8’)
    update T_COMM_DETAIL set ProduetType=4
      where (month=ThisMonth) and (year=ThisYear) and
          (ProductCode like ‘o%’)
    update T_COMM_DETAIL set ProductType=5
      where (month=ThisMonth) and (year=ThisYear) and
          (ProductType=3) and (BusinessCode<>‘elc’)
    update T_COMM_DETAIL set ProductType=3
      where (month=ThisMonth) and (year=ThisYear) and
          (ProduetType=1) and (Account=‘L9911’) and
          (ClearingCharge=0) and (ExecutionCharge<>0)
    update T_COMM_DETAIL set ProductType=5
      where (month=ThisMonth) and (year=ThisYear) and
          (ProductType=1) and (Account=‘L9911’) and
          (ClearingCharge=0) and (ExecutionCharge<>0)
    update T_COMM_DETAIL set ProductType=6
      where (month=ThisMonth) and (year=ThisYear) and
          (BusinessCode=‘tax’)
    -- Set Fixed fees
    update T_COMM_DETAIL set Fee=Fee +
T_COMM_FEESCHEDULEDETAIL.FixedFee
      where (month=ThisMonth) and (year=ThisYear)
    -- Set Variable Fees
    update T_COMM_DETAIL set Fee=Fee +
(Quantity*T_COMM_FEESCHEDULEDETAIL.VariableFee)
      where (month=ThisMonth) and (year=ThisYear)
    -- Remove fees for 12-b1's
    update T_COMM_DETAIL set Fee=0
      where (month=ThisMonth) and (year=ThisYear) and
          (SecurityDescription starts with ‘12’)
    -- Set Discounting Fees
    update T_COMM_DETAIL set Fee=19.00
      where (month=ThisMonth) and (year=ThisYear) and
          (FeeSchedule=‘2’ or ‘5’) and (abs(Commissions)<55) and
          (ProductCode like ‘cs%’) and (ProductType=1) and
          (ClearingCharge<>0)
    update T_COMM_DETAIL set Fee=19.00 + abs(0.0125*Quantity)
      where (month=ThisMonth) and (year=ThisYear) and
          (FeeSchedule=‘2’ or ‘5’) and (abs(Commissions)<55+
          abs(Quantity)*0.03)
and
          (ProductType=3) and (ClearingCharge<>0)
    update T_COMM_DETAIL set Fee=19.00 + abs(0.01*Quantity)
      where (month=ThisMonth) and (year=ThisYear) and
          (FeeSehedule=‘2’) and (abs(Commissions)<55+
          abs(Quantity)*0.03) and
          (ProductType=3) and (ClearingCharge<>0)
    update T_COMM_DETAIL set Fee=19.00 + abs(1 .55*Quantity)
      where (month=ThisMonth) and (year=ThisYear) and
          (FeeSchedule‘2’ or ‘5’) and (abs(Commissions)<55+
          abs(Quantity)*2)
and
          (ProductType=4) and (ClearingCharge<>0)
    update T_COMM_DETAIL set Fee=19.00 + abs(0.85*Quantity)
      where (month=ThisMonth) and (year=ThisYear) and
          (FeeSehedule=‘2’) and (abs(Commissions)<55+
          abs(Quantity)*2) and
          (ProductType=4) and (ClearingCharge<>0)
    -- Adjust Fees for cancels
    update T_COMM_DETAIL set Fee= −1 * Fee
      where (month=ThisMonth) and (year=ThisYear) and
          (Transaction is a cancel)
    -- Adjust fees for Overrides
    update T_COMM_DETAIL set Fee = Fee *
T_COMM_OVERRIDEDETAIL.Percent
      where (month=ThisMonth) and (year=ThisYear)
    -- Set Fees=0 for debited overrides
    update T_COMM_DETAIL set Fee=0
      where (month=ThisMonth) and (year=ThisYear) and
          (T_COMM_OVERRTDE.Type=1)
    -- Set Net Amount
    update T_COMM_DETAIL set Net=Gross*Payout
      where (month=ThisMonth) and (year=ThisYear)
    -- Subtract the fees from the net to get the final net
    update T_COMM_DETAIL set Net=Net−Fees
      where (month=ThisMonth) and (year=ThisYear)
    ------------------------
    -- Summary Processing --
    ------------------------
    -- Remove Previous Entries
    delete from T_COMM_NETPAYABLE where
(month=ThisMonth) and (year=ThisYear)
    -- Insert entries from the T_CSC_DETAIL table
    insert summed amounts into T_COMM_NETPAYABLE
      entries from T_COMM_DETAIL where (month=ThisMonth) and
(year=ThisYear)
    insert summed amounts into T_COMM_NETPAYABLE
      entries from T_COMM_OVERRIDEDETAIL where
      (month=ThisMonth)
and (year=ThisYear)
```

What is claimed is:

1. A net commission processing system comprising:
a raw data table storing as a set of entries substantially all data provided by a financial entity;
a base data table storing a base set of data, the base set comprising a subset of the set of entries in the raw data table and created by logically operating on the raw data table;
a summary data table having a set of summary entries resulting from logically operating on the base set; and
a report generation means for generating a report from the set of summary entries.

2. The net commission processing system of claim 1, further comprising:
a manually maintained table containing at least one manually inputted entry; and wherein:
the base set is further created by logically operating on the manually maintained table.

3. The net commission processing system of claim 2, further comprising at least one customizable module.

4. The net commission processing system of claim 3, wherein the customizable module logically operates on the base set of data to form the set of summary entries.

5. The net commission processing system of claim 4, wherein the customizable module comprises software modified in accordance with a client's unique case.

6. A net commission processing system comprising
first means for receiving raw data from a plurality of data sources;
at least one raw data table for storing said raw data received from said plurality of data sources;
second means for manipulating said raw data into manipulated data;
at least one base data table for storing said manipulated data;
third means for processing said manipulated data into processed data;
at least one summary data table for storing said processed data; and
fourth means for generating a plurality of reports from said processed data.

7. The net commission processing system of claim 6 further comprising at least one supplemental data table for storing at least a portion of said manipulated data.

8. A net commission processing system comprising
first means for receiving raw data from a plurality of data sources;
at least one raw data table for storing said raw data received from said plurality of data sources;
second means for receiving manually maintained data;
at least one manually maintained table for storing said manually maintained data;
third means for manipulating said raw data and said manually maintained data into manipulated data;
at least one base data table for storing said manipulated data;
fourth means for processing said manipulated data and said manually maintained data into processed data;
at least one summary data table for storing said processed data; and
fifth means for generating a plurality of reports from said processed data.

9. The net commission processing system of claim 8, wherein said fourth means comprises at least one customizable module.

10. The net commission processing system of claim 9, wherein said at least one customizable module comprises software modified according to a client's unique cases.

11. The net commission processing system of claim 8, wherein said first, second, and third means remain static, and further wherein said fourth means comprises a customizable module.

12. A method for creating a net commissions report, comprising:
receiving raw data from at least one data source;
storing the raw data as a set of raw data entries in a raw data table;
manipulating the set of raw data entries to create base data;
storing the base data as a set of base data entries in a base data table;
determining which base data entries are required to generate a report;
in response to determining which base data entries are required to generate a report, processing the required base data entries to form a set of summary data entries;
storing the set of summary data entries in a summary data table; and
generating a report based on the set of summary data entries.

13. The method of claim 12, wherein the step of manipulating the raw data to create base data comprises combining a first raw data entry and a second raw data entry to form a single base data entry.

14. The method of claim 12, wherein the step of manipulating the set of raw data entries to create base data comprises formatting the raw data entries.

15. The method of claim 12, further comprising:
receiving manual data from at least one manual data source;
storing the manual data as a set of manual data entries in a manually manipulated data table; and
manipulating the set of manual data entries to create base data.

16. A method for creating a custom report satisfying a client's unique case, comprising:
interviewing the client to ascertain a client's unique case;
determining a report having a format, the report complying with the unique case;
receiving raw data;
storing the raw data as a set of raw data entries in a raw data table;
manipulating the set of raw data entries to create base data;
storing the base data as a set of base data entries in a base data table;
creating a custom code within a custom module;
processing, via the custom code, the set of base data entries to create summary data;
storing the summary data as a set of summary data entries in a summary data table; and
generating the report from the set of summary data entries.

17. The method of claim 16 wherein the step of processing, via the custom code, the set of base data entries comprises:
determining a necessary data set to generate the report;
analyzing the set of base data entries to determine which of the set of base data entries is part of the necessary data set; and
manipulating the necessary data set to conform to a summary data table format.
